(19) United States
(12) Patent Application Publication
(10) Pub. No.: US 2026/0341960 A1
(43) Pub. Date: Oct. 29, 2026

(54) RADIO WAVE REFLECTING BODY, MANUFACTURING METHOD FOR RADIO WAVE REFLECTING BODY, CONSTRUCTION METHOD FOR RADIO WAVE REFLECTING BODY

(71) Applicant: SEKISUI CHEMICAL CO., LTD., Osaka (JP)

(72) Inventors: Danichi MIYAZAKI, Osaka (JP); Munehiro HATAI, Osaka (JP)

(73) Assignee: SEKISUI CHEMICAL CO., LTD., Osaka (JP)

(21) Appl. No.: 19/099,161

(22) PCT Filed: Aug. 2, 2023
(86) PCT No.: PCT/JP2023/028314

§ 371 Date: Jan. 28, 2025

(30) Foreign Application Priority Data
Aug. 2, 2022 (JP) 2022-123574
Aug. 2, 2022 (JP) 2022-123578

(51) Int. Cl. H01Q 3/34; H01Q 15/14

(52) U.S. Cl. CPC H01Q 3/34; H01Q 15/14

(57) ABSTRACT

An electric conductor is protected to not lose radio wave reflectivity. A radio wave reflector 11 includes a conductive layer 16 including an electric conductor 12 to reflect radio waves and a protective layer 15 to protect the conductive layer 16. The protective layer 15 has a pencil hardness of F or higher under a surface load of 500 g in a pencil hardness test performed on the radio wave reflector 11.

### TECHNICAL FIELD

The present invention relates to a radio wave reflector.

### BACKGROUND ART

Cellular phones and wireless communications use radio waves in the frequency range of about 3 GHz or more and 300 GHz or less, called “centimeter waves” or “millimeter waves.” Such radio waves with short wavelengths have a high degree of straight-advancing properties and are unlikely to bend around obstacles. Thus, in order to allow the radio waves to reach a wide area, reflectors are installed on the surfaces of buildings, such as walls, floors, ceilings, and pillars of buildings (“walls etc.” below).

For example, PTL 1 discloses a communication system that includes monopole antennas and a metal reflector to reflect radio waves arranged in an indoor underfloor space. The metal reflector diffuses the radio waves emitted from the monopole antennas into the space under the floor, preventing the waves from leaking from the underfloor space to the outside of a living room (building) or from being absorbed by the floor of a building.

### CITATION LIST

### Patent Literature

PTL 1: JP2010-258514A

### SUMMARY OF INVENTION

### Technical Problem

Conventional metal reflectors are those simply made of metal. To allow metal reflectors to reflect radio waves more efficiently, the present inventors came up with the idea of laminating a conductive layer containing an electric conductor and a protective layer that protects the conductive layer.

However, if the surface of the protective layer has a low level of hardness, the electric conductor may not be protected sufficiently, and radio wave reflectivity may be impaired.

An object of the present invention is to provide a radio wave reflector that protects an electric conductor and prevents loss of radio wave reflectivity.

### Solution to Problem

To achieve the object above, the present invention includes the subject matter described in the following items.
Item 1. A radio wave reflector, comprising
   a conductive layer containing an electric conductor to reflect a radio wave, and
   a protective layer to protect the conductive layer,
   the protective layer having a pencil hardness of F or higher under a surface load of 500 g in a pencil hardness test performed on the radio wave reflector.
Item 2. The radio wave reflector according to Item 1, wherein the protective layer has a thickness of 38 μm or more.
Item 3. The radio wave reflector according to Item 1 or 2, wherein the protective layer has a pencil hardness of F or higher under a surface load of 500 g in a pencil hardness test performed on the protective layer.
Item 4. The radio wave reflector according to any one of Items 1 to 3, further comprising an adhesive layer between the conductive layer and the protective layer, the adhesive layer bonding the conductive layer and the protective layer,
   wherein the adhesive layer has a hydroxyl value of 5 mg KOH/g or more.
Item 5. The radio wave reflector according to any one of Items 1 to 4, further comprising an adhesive layer between the conductive layer and the protective layer, the adhesive layer bonding the conductive layer and the protective layer,
   wherein the adhesive layer has an acid value of 50 mg KOH/g or less.
Item 6. The radio wave reflector according to any one of Items 1 to 5, wherein the protective layer has a moisture permeability of 20 g/m²·24 h or less at 40 °C and 90% RH.
Item 7. The radio wave reflector according to any one of Items 1 to 6, wherein a rate of decrease in adhesive strength of the protective layer to an adherend layer after a heat and moisture resistance test is 50% or less.
Item 8. The radio wave reflector according to any one of Items 1 to 7, wherein the radio wave reflector has a total light transmittance of 705 or more.
Item 9. The radio wave reflector according to any one of Items 1 to 8, further comprising an adhesive layer between the conductive layer and the protective layer, the adhesive layer bonding the conductive layer and the protective layer,
   wherein the adhesive layer does not contain a UV inhibitor.
Item 10. The radio wave reflector according to any one of Items 1 to 9,
wherein
   the conductive layer has a region in which the electric conductor is not present and has the electric conductor formed so as to surround the region,
   the region includes a plurality of regions of the same shape, and
   the plurality of regions of the same shape are arranged at a regular interval.
Item 11. The radio wave reflector according to any one of Items 1 to 10, wherein the radio wave reflector has a surface resistivity of 100Ω/□ or less after a heat and moisture resistance test.
Item 12. The radio wave reflector according to any one of Items 1 to 11, wherein the protective layer either contains a UV inhibitor or has a surface treated to block UV, or both.
Item 13. The radio wave reflector according to any one of Items 1 to 12, wherein the radio wave reflector has a haze of 30% or less.
Item 14. The radio wave reflector according to any one of Items 1 to 13, wherein the radio wave reflector has a total light transmittance of 705 or more after a lightfastness test.
Item 15. The radio wave reflector according to any one of Items 1 to 14, wherein the radio wave reflector has an yellowness Δb* of 15 or less before and after a lightfastness test.
Item 16. The radio wave reflector according to any one of Items 1 to 15, comprising a laminate of the protective layer and the conductive layer, wherein the entire electric conductor is covered by the protective layer in a plan view.
Item 17. The radio wave reflector according to Item 16, wherein
   the laminate further contains an adhesive layer that bonds the protective layer and the conductive layer,
   the electric conductor is disposed medially from an edge of the protective layer in a plan view, and
   the electric conductor is covered by the adhesive layer in a lateral view.
Item 18. The radio wave reflector according to Item 17,
wherein
   the conductive layer further contains a substrate supporting the electric conductor,
   the electric conductor is located between the substrate and the protective layer, and
   the electric conductor is disposed medially from an edge of the substrate in a plan view.
Item 19. The radio wave reflector according to any one of Items 16 to 18, wherein the electric conductor is disposed at least 5 mm medially from an edge of the protective layer in a plan view.
Item 20. The radio wave reflector according to any one of Items 16 to 19, wherein a sealant is present around the laminate, at least in a position corresponding to the conductive layer so as not to expose the electric conductor.
Item 21. The radio wave reflector according to any one of Items 16 to 20,
wherein
   a difference in yellow index between after a heat and moisture resistance test and before the heat and moisture resistance test is 3 or less, wherein the heat and moisture resistance test includes leaving the radio wave reflector in a chamber of constant temperature and constant humidity adjusted to a temperature of 60 °C and a humidity of 95% RH for 500 hours, then removing the radio wave reflector from the chamber, and allowing the radio wave reflector to stand at room temperature for 4 hours.
Item 22. The radio wave reflector according to any one of Items 1 to 21,
wherein
   when the radio wave reflector after a heat and moisture resistance test and the radio wave reflector before the heat and moisture resistance test specularly reflect incident waves with a frequency of 3 GHz or more and 300 GHz or less, there is at least one frequency of an incident wave at which a difference in intensity between a wave reflected by the radio wave reflector after the heat and moisture resistance test and a wave reflected by the radio wave reflector before the heat and moisture resistance test is within 3 dB, and
   the heat and moisture resistance test includes leaving the radio wave reflector in a chamber of constant temperature and constant humidity adjusted to a temperature of 60 °C and a humidity of 95% RH for 500 hours, then removing the radio wave reflector from the chamber, and allowing the radio wave reflector to stand at room temperature for 4 hours.
Item 23. A method for producing the radio wave reflector of Item 20, comprising the steps of
   forming the laminate, and
   providing the sealant to not expose the electric conductor,
   the sealant being present around the laminate, at least in a position corresponding to the conductive layer in the radio wave reflector.
Item 24. A method for installing the radio wave reflector of Item 20, comprising the steps of
   attaching the laminate to an installation site, and
   providing the sealant to not expose the electric conductor,
   the sealant being present around the laminate, at least in a position corresponding to the conductive layer in the radio wave reflector.
Item 25. The method according to Item 24,
wherein
   the laminate comprises a plurality of the laminates,
   in the attaching step, the laminates are attached to an installation site with an interval therebetween, and
   in the sealant providing step, the sealant is provided in space between adjacent laminates of the laminates attached to the installation site with an interval therebetween.

### Advantageous Effects of Invention

The radio wave reflector according to the aspects of the present invention above is advantageous in that the radio wave reflector can protect the electric conductor and prevent the loss of radio wave reflectivity.

### BRIEF DESCRIPTION OF DRAWINGS

FIG. 1 is a diagram describing the angular range of a wave reflected by a radio wave reflector according to an embodiment.

FIG. 2 is a schematic cross-sectional view of a radio wave reflector according to an embodiment.

FIG. 3(A) is a schematic plan view of the entire radio wave reflector according to an embodiment.

FIG. 3(B) is a magnified view of part A in FIG. 3(A).

FIG. 4 is a magnified view of part C in FIG. 3(A).

FIGS. 5(A) to 5(E) are schematic plan views showing variation examples of the arrangement pattern of electric conductors.

FIG. 6(A) is a diagram showing an example of use of a radio wave reflector according to an embodiment.

FIG. 6(B) is a schematic plan view showing an example of application of a building material in an indoor space.

FIG. 7(A) is a schematic plan view of the entire radio wave reflector according to another embodiment.

FIG. 7(B) is a schematic cross-sectional view of a portion of the radio wave reflector according to another embodiment.

FIG. 8 is a schematic plan view of the entire radio wave reflector according to another embodiment.

FIG. 9 is a schematic cross-sectional view of a radio wave reflector according to variation example 1.

FIG. 10 is a schematic cross-sectional view of a radio wave reflector according to variation example 2.

FIG. 11(A) is a schematic plan view of a radio wave reflector according to variation example 3.

FIG. 11(B) is a magnified view of part B in FIG. 11(A).

FIG. 12(A) is a schematic plan view of a radio wave reflector according to variation example 4.

FIG. 12(B) is a magnified view of part B in FIG. 12(A).

### DESCRIPTION OF EMBODIMENTS

### Embodiment

### Overall Structure of Radio Wave Reflector 11

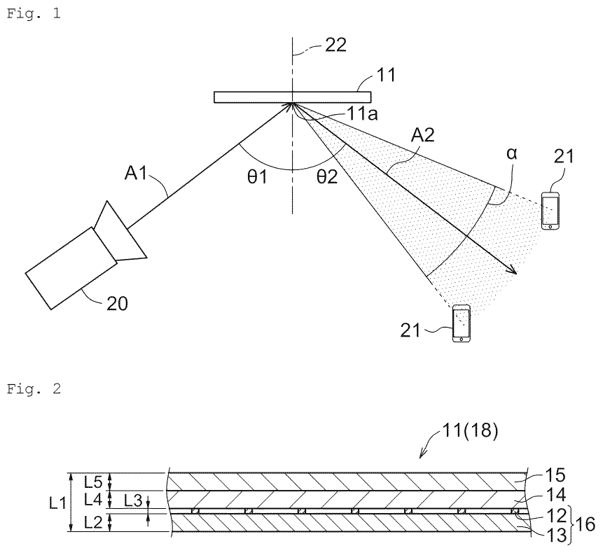

An embodiment of the present invention is described below with reference to drawings. As shown in FIG. 1, a radio wave reflector 11 according to the present embodiment is a sheet-shaped member capable of reflecting radio waves. The radio wave reflector 11 is configured to reflect, for example, radio waves output from a radio wave generator 20. The radio waves reflected by the radio wave reflector 11 are received by a receiver 21. As shown in FIG. 2, the radio wave reflector 11 contains a conductive layer 16 including an electric conductor 12, an adhesive layer 14, and a protective layer 15 stacked in this order.

The term “sheet” as used in the present specification refers to a shape of an object that has a thickness of 10% or less of the maximum length between the outer edges in a plan view. When the shape in a plan view is rectangular, “the maximum length between the outer edges in a plan view” means the length of the diagonal. When the shape in a plan view is circular, the “maximum length between the outer edges in a plan view” means the length of the diameter. In the present specification, the term “sheet” also encompasses membranes, foils, films, and the like.

The radio wave generator 20 is a device to output radio waves. The radio wave generator 20 according to the present embodiment is a communication device with a transmitting antenna capable of outputting a wireless signal using radio waves as a medium. Examples of the radio wave generator 20 include fixed base stations, mobile base stations, radio wave transmitters, and wireless terminals.

The receiver 21 is a device capable of receiving radio waves. The receiver 21 according to the present embodiment is a communication device with a receiving antenna. Examples of the receiver 21 include smartphones, cellular phones, tablet computing devices, laptop computers, portable game consoles, repeaters, radios, and televisions.

The radio waves that can be reflected by the radio wave reflector 11 according to the present embodiment refer to radio waves with an incident wave frequency in any of the ranges of 3 GHz or more to 5 GHz or less, 25 GHz or more to 30 GHz or less, and 100 GHz or more to 300 GHz or less, for example. The phrase “radio waves that can be reflected” as used herein means that the radio waves contain at least one radio wave whose outgoing wave reflected specularly has an intensity of −30 dB or more and 0 dB or less relative to the intensity of an incident wave with an incident angle of 15 degrees or more and 75 degrees or less (which may sometimes be referred to as “specular reflection intensity”). It is preferred that the specular reflection intensity be −30 dB or more and 0 dB or less for any incident wave with an incident angle of 15 degrees or more and 75 degrees or less.

More specifically, the specular reflection intensity is preferably −30 dB or more and 0 dB or less at a frequency of 28.5 GHz with respect to the incident wave, more preferably −30 dB or more and 0 dB or less with respect to the incident wave in the entire frequency band of 20 GHz or more to 60 GHz or less, and even more preferably −30 dB or more and 0 dB or less with respect to the incident wave in the entire frequency band of 3 GHz or more to 300 GHz or less.

The specular reflection intensity is preferably less attenuated relative to the intensity of the incident wave. The specular reflection intensity relative to the intensity of the incident wave is preferably −25 dB or more and 0 dB or less, more preferably −22 dB or more and 0 dB or less, even more preferably −20 dB or more and 0 dB or less, and still more preferably −15 dB or more and 0 dB or less.

A specular reflection intensity relative to the intensity of the incident wave being −30 dB or more allows the radio wave reflector 11 to reflect radio waves while maintaining the reflection intensity. This enables the receiver 21 to receive radio waves with a practical intensity. In the present specification, the phrases “reflection intensity” and “specular reflection intensity” refer to an intensity when the distance between a reflection point 11a and a measurement point is 1 m. The specular reflection intensity is measured with the radio wave reflector 11 being placed in a planar state without curving or folding the radio wave reflector 11.

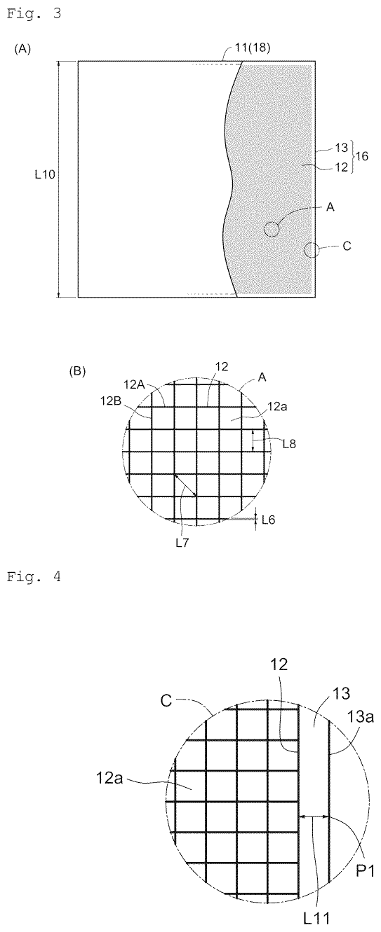

As shown in FIG. 3, the radio wave reflector 11 according to the present embodiment has a quadrilateral shape (including a square and a rectangle) in a plan view. The length L10 of one side of the radio wave reflector 11 is, for example, preferably 20 cm or more, more preferably 100 cm or more, and even more preferably 200 cm or more. There is no particular upper limit to the length L10 of one side of the radio wave reflector 11; for example, the length L10 is 400 cm or less. The radio wave reflector 11 with the length L10 of 20 am or more is more likely to reflect radio waves with sufficient intensity.

The shape of the radio wave reflector 11 is not limited to a quadrilateral shape; the radio wave reflector 11 may be of a geometric shape, such as a triangle, a pentagon, a hexagon, a circle, or an ellipse, or of a non-geometric shape. The radio wave reflector 11 preferably has a maximum distance between the edges within the range of 20 cm or more and 400 am or less. The “maximum distance between the edges” refers to the diagonal dimension if the radio wave reflector 11 is rectangular, refers to the diameter if the radio wave reflector 11 is circular, and refers to the length of the major axis if the radio wave reflector 11 is elliptical.

The thickness L1 of the radio wave reflector 11 is preferably 0.01 mm or more, more preferably 0.05 mm or more, and even more preferably 0.2 mm or more. The upper limit of the thickness L1 of the radio wave reflector 11 is preferably 0.5 mm or less, and more preferably 0.4 mm or less. The radio wave reflector 11 with a thickness L1 of 0.01 mm or more can maintain its strength while having flexibility. Setting the thickness L1 of the radio wave reflector 11 to 0.5 mm or less makes it less likely for the radio wave reflector 11 to bend over when curved, thus making it less likely for stress to concentrate in the electric conductor 12. The phrase “bend over” used herein means bending accompanied by plastic deformation occurring in some of the layers of the radio wave reflector 11.

A pencil hardness test performed on the radio wave reflector 11 preferably results in a pencil hardness of “F” or higher, more preferably “H” or higher, and even more preferably “4H” or higher under a surface load of 500 g on the protective layer 15. The “pencil hardness test” referred to in the present specification is a test conforming to JIS K 5600-5-4 (1999). A load of 500 g±10 g applied to the surface during a pencil hardness test is also included in the phrase “a surface load of 500 g.”

Additionally, after the radio wave reflector 11 undergoes a heat and moisture resistance test, the rate of decrease in adhesive strength of the protective layer 15 to the adherend layer is preferably 50% or less, more preferably 45% or less, and even more preferably 40% or less. As used in the present specification, the phrase “adherend layer” refers to a layer that is in direct contact with the layer of interest. In the present embodiment, the adherend layer for the protective layer 15 is the adhesive layer 14. The adhesive strength is measured according to a tensile adhesive strength test in accordance with JIS K 6849 (1994).

The heat and moisture resistance test is performed as follows: the radio wave reflector 11 is placed in a chamber of constant temperature and constant humidity adjusted to a temperature of 60 °C and a humidity of 95% RH (relative humidity) and left to stand for 500 hours; then, the radio wave reflector 11 is removed from the chamber of constant temperature and constant humidity and allowed to stand at room temperature for 4 hours, after which changes in the properties are examined.

It is preferred that the difference in intensity between the wave reflected by the radio wave reflector 11 after a heat and moisture resistance test and the wave reflected by the radio wave reflector 11 before the heat and moisture resistance test be within 3 dB. The incident angle of the incident wave at which the difference in intensity of the reflected wave before and after a heat and moisture resistance test is within 3 dB is preferably at least one angle present in the range of 15 degrees or more to 75 degrees or less, more preferably 45 degrees, and even more preferably all angles present in the range of 15 degrees or more to 75 degrees or less. The frequency of the incident wave at which the difference in intensity of the reflected wave before and after a heat and moisture resistance test is within 3 dB is preferably at least one frequency present in the frequency band of 3 GHz or more to 300 GHz or less, and more preferably all frequencies in the frequency band of 3 GHz or more to 300 GHz or less.

The surface resistivity of the radio wave reflector 11 after a heat and moisture resistance test is preferably 100Ω/□ or less, more preferably 50Ω/□ or less, and even more preferably 20Ω/□ or less. A surface resistivity of 20Ω/□ or less after a heat and moisture resistance test allows the radio wave reflector 11 to maintain its practicality without losing reflection intensity even after being placed in a high-temperature and high-humidity environment for a long time.

The surface resistivity of the radio wave reflector 11 before a heat and moisture resistance test is preferably 0.003Ω/□ or more and 10Ω/□ or less, more preferably 0.01Ω/□ or more and 9Ω/□ or less, and even more preferably 0.02Ω/□ or more and 8Ω/□ or less. The surface resistivity is a value as measured with the radio wave reflector 11 placed on a flat table.

The rate of change in surface resistivity of the radio wave reflector 11 after a heat and moisture resistance test relative to the surface resistivity before the heat and moisture resistance test is preferably 20% or less, more preferably 17% or less, and even more preferably 15% or less. The rate of change r is calculated according to r=(r₁−r₂)/r₁×100, wherein r₁ represents the surface resistivity before a heat and moisture resistance test, and r₂ represents the surface resistivity before the heat and moisture resistance test.

The reflection intensity of a radio wave changes according to surface resistivity. If the rate of change r in surface resistivity of the radio wave reflector 11 is small, reflection intensity is less likely to decrease. Because the rate of change r in surface resistivity of the radio wave reflector 11 during a heat and moisture resistance test is 20% or less, the reflection intensity of the radio wave reflector 11 does not decrease significantly even after a heat and moisture resistance test, and sufficient reflection intensity of radio waves can be achieved.

The radio wave reflector 11 may have a rate of change R in surface resistivity of −10% or more and 10% or less before and after the radio wave reflector 11 is curved along the surface of a member having a curved surface with a radius of curvature of 200 mm (which is also referred to as “the rate of change R in surface resistivity when curved”). The rate of change R in surface resistivity when curved means the percentage of change in surface resistivity R₂ of the radio wave reflector 11 curved along the surface of a member having a curved surface with a radius of curvature of 200 mm relative to surface resistivity R₁ of the radio wave reflector 11 placed in a flat state. The rate of change R in surface resistivity is calculated according to R=(R₂−R₁)/R₁×100.

The reflection intensity of radio waves varies according to surface resistivity. However, because the rate of change R in surface resistivity of the curved radio wave reflector 11 is −10% or more and 10% or less, sufficient reflection intensity of radio waves can be achieved even with the curved radio wave reflector 11, in a similar manner as with the radio wave reflector 11 placed flat.

In the present specification, surface resistivity means the surface resistance per square centimeter. The surface resistivity can be measured according to a four-terminal method in accordance with JIS K 6911 by brining measurement terminals into contact with the surface of the conductive layer. The surface resistivity is measured as the surface resistivity of the electric conductor 12 of the conductive layer 16. If the electric conductor 12 of the conductive layer 16 is not exposed because of protection with a resin sheet or the like, surface resistivity can be measured according to the eddy-current method using a non-contact resistance meter (manufactured by Napson Corporation, product name: EC-80P, or an equivalent product).

It is preferred that the radio wave reflector 11 as a whole has visible light transmittance. Specifically, it is preferred that the radio wave reflector 11 is transparent. The conductive layer 16, the adhesive layer 14, and the protective layer 15 may be formed of a material with visible light transmittance and/or so as to have a thickness that ensures visible light transmittance. “Transparent” as used herein means that an object on one side of the radio wave reflector 11 can be seen from the other side, and total light transmittance does not have to be 100%. The term “transparent” includes the meaning of “semi-transparent.” The radio wave reflector 11 may also be colored.

The radio wave reflector 11 preferably has a total light transmittance of 70% or more, more preferably 75% or more, and even more preferably 80% or more. In the present specification, total light transmittance refers to the transmittance of light beams from a standard illuminant D65. Total light transmittance is measured in accordance with JIS K 7375 (2008). The radio wave reflector 11 preferably has a total light transmittance of 70% or more, more preferably 75% or more, and even more preferably 80% or more, even after a lightfastness test, described below.

The radio wave reflector 11 preferably has a haze of 30% or less. Haze means the degree of cloudiness of the radio wave reflector 11, and is defined in JIS-K7136:2000. In particular, it is preferred that the haze is 30% or less even after a lightfastness test.

The lightfastness test is as follows: The radio wave reflector 11 is placed in a chamber of a measurement instrument (e.g., a Ci4000 xenon Sunshine Weather-Ometer manufactured by Atlas Material Testing Technology LLC). The measurement instrument is set to an irradiance of 60 W/m² (300 to 400 nm) inside the chamber, a black standard temperature (BST) of 65±3 °C, a humidity of 50±5% RH, and a temperature inside the chamber of 38 °C. The radio wave reflector 11 is then irradiated with light for 1,300 hours (equivalent to one year of direct sunlight) to examine changes in the properties of the radio wave reflector 11.

The yellowness Δb* of the radio wave reflector 11 before and after the lightfastness test is preferably 15 or less. The yellowness Δb* is the difference (b*2−b*1) between the intensity b*l of the color (yellow)+b* before the lightfastness test and the intensity b*2 of the color (yellow)+b* after the lightfastness test in the L*a*b* color space defined by the International Commission on Illumination (CIE). A higher value indicates a more intense discoloration to yellow. If yellowness Δb* is 15 or less, the change in the color of the radio wave reflector 11 to yellow becomes less visible, with the effects of discoloration and deterioration being small. Yellowness Δb* is measured in accordance with JIS Z 8781-4.

The difference between the yellow index of the radio wave reflector 11 after a heat and moisture resistance test and the yellow index before the heat and moisture resistance test is 3 or less. The yellow index, also known as “yellowness,” refers to the degree to which a hue deviates from colorless or white toward yellow. The yellow index is determined according to a method in accordance with JIS K 7373:2006. The difference in the yellow index is an index for evaluating the change of color to yellow, which is one of the degradation phenomena of the radio wave reflector 11. A smaller difference in the yellow index indicates a smaller degree of degradation. The yellow index differs from the yellowness Δb* above and is determined by using the XYZ color space defined by the CIE.

The bending elastic modulus of the radio wave reflector 11 is preferably 0.05 GPa or more and 4 GPa or less. Setting the bending elastic modulus within this range allows the radio wave reflector 11 to have flexibility and thus makes it possible to curve and adhere the radio wave reflector 11 to a curved or spherical surface without folding or breaking the radio wave reflector 11. The bending elastic modulus is measured in accordance with JIS K 7171. In the present specification, “flexibility” refers to the properties of being able to bow without being broken or plastically deformed even when a bending force is applied at room temperature under ordinary pressure.

The radio wave reflector 11 preferably has a longitudinal elastic modulus of 0.01 GPa or more and 80 GPa or less. Setting the longitudinal elastic modulus within this range makes it easier for the radio wave reflector 11 to deform and thus allows the radio wave reflector 11 to curve and adhere to a curved surface with a radius of curvature of 200 mm or more without rapture. The longitudinal elastic modulus is also called “Young's modulus” or “tensile modulus,” as defined in JIS K7161-2014, and measured in accordance with JIS K 7127 (1999).

The radio wave reflector 11 according to the present embodiment has at least a degree of flexibility that allows the radio wave reflector 11 to be adhered along a curved surface with a radius of curvature of 200 mm or more, and preferably has a degree of flexibility that allows the radio wave reflector 11 to be adhered along a curved surface with a radius of curvature of 100 mm or more.

The radio wave reflector 11 may have plasticity. Plasticity refers to the properties of being deformable upon application of external pressure, and being able to maintain the deformed shape when deformed beyond the elastic limit by pressure applied and then released from the force. The conductive layer 16, the adhesive layer 14, and the protective layer 15 may all have plasticity, or at least one of them may have plasticity.

The surface roughness Sa of the electric conductor 12 is not particularly limited, and is preferably 1 μm or more and 7 μm or less, and more preferably 1.03 μm or more and 6.72 μm or less. A surface roughness Sa within this range makes it easier to diffuse and reflect radio waves.

The surface roughness Sa is determined by the arithmetic mean height according to ISO 25178 and measured in accordance with ISO 25178. The surface roughness Sa of the electric conductor 12 can be determined by measuring the surface roughness at multiple points on the surface of the electric conductor 12 by using a laser microscope (product name: VK-X1000/1050, manufactured by Keyence Corporation, or an equivalent product) and calculating the average of the measured values.

In a virtual plane including an incident wave A1 and its reflected wave as shown in FIG. 1, when the reception angle position of the reflected wave is changed within an angle range α of −15 degrees or more to +15 degrees or less with respect to a reflected wave A2 of specular reflection, the kurtosis of the distribution of the reflected wave intensity at each reception angle position is preferably −0.4 or less in the radio wave reflector 11. The kurtosis is more preferably −1.0 or less, even more preferably −1.1 or less, and still more preferably −1.2 or less. The lower limit of the kurtosis is, but not particularly limited to, for example, −0.5 or more. On the virtual plane, a reflection point 11a on the reflection surface of the radio wave reflector 11, a radio wave source 20, and a receiver 21 for reflected waves are positioned. The kurtosis is measured with the radio wave reflector 11 being placed flat.

Kurtosis is a statistic that expresses how much a distribution deviates from the normal distribution, and indicates the sharpness of the peaks and the broadness of the tails. As shown in FIG. 1, it is assumed that a radio wave emitted from the radio wave source 20 is incident on the radio wave reflector 11 at an incident angle θ1 and reflects specularly at a reflection angle θ2. While a reception angle position i of the receiver 21 is moved by a predetermined angle (e.g., 5 degrees) around the reflection point 11a as the center within an angle range a of −15 degrees or more to +15 degrees or less with respect to the specular reflection wave A2 resulting from specular reflection of the radio wave, a reflection intensity x is measured. The reception angle position i of the receiver 21 is located on an arc with the reflection point 11a as its center.

The kurtosis is calculated according to the following formula:

$$Kurtosis = \frac{n ( n + 1 )}{( n - 1 ) ( n - 2 ) ( n - 3 )} {\sum }_{i = 1}^{n} \frac{{( {x}_{i} - \overline{x} )}^{4}}{{s}^{4}} - \frac{3 {( n - 1 )}^{2}}{( n - 2 ) ( n - 3 )}$$

wherein
x̅
represents the average of the reflection intensity values xᵢ (i: 1, 2 . . . , n) at each reception angle position i, and s represents the standard deviation.

Negative kurtosis values indicate that the distribution of intensity data at individual angle positions is flatter than the normal distribution; i.e., the data are spread from around the average value with a wider tail of distribution. A smaller kurtosis value indicates a flatter distribution. In the present embodiment, the kurtosis is set to −0.4 or less, thereby resulting in a small difference in reflection intensity due to the reception angle position within the angle range α of ±15 degrees for the specular reflection wave.

### Structure of Each Layer of Radio Wave Reflector 11

Each layer of the radio wave reflector 11 is described in more detail below. In the following description, the direction in which multiple layers are stacked is defined as the “up-down direction.” The “vertical direction” and the “horizontal direction” are defined based on the radio wave reflector 11 viewed in the up-down direction. However, these directional definitions are used only for the purpose of explanation and are not intended to specify any particular application. The figures are also merely schematic diagrams and are not drawn to actual scale.

As shown in FIG. 2, the radio wave reflector 11 includes a laminate 18 in which a plurality of layers are stacked. The laminate 18 includes the conductive layer 16, including the electric conductor 12 configured to reflect radio waves, and a protective layer 15 configured to protect the conductive layer 16. The laminate 18 may further include the adhesive layer 14 containing an adhesive for bonding the conductive layer 16 and the protective layer 15. In the present embodiment, the radio wave reflector 11 includes the adhesive layer 14 and the protective layer 15 stacked in this order on the electric conductor 12 of the conductive layer 16.

### Conductive Layer 16

The conductive layer 16 is a layer containing the electric conductor 12. The conductive layer 16 includes the substrate 13 and the electric conductor 12 configured to reflect radio waves. The electric conductor 12 is located between the substrate 13 and two layers (i.e., the adhesive layer 14 and the protective layer 15). The conductive layer 16 may be composed of the electric conductor 12 without including the substrate 13. In this case, the protective layer 15 serves as a substrate 13 to support the electric conductor 12.

### Substrate 13

The substrate 13 supports the electric conductor 12. In the present embodiment, the substrate 13 is formed so as to have a rectangular outer shape (more specifically, square) in a plan view. The substrate 13 is formed with a uniform thickness over the entire surface. However, the thickness of the substrate 13 does not have to be uniform; for example, the substrate 13 may be formed in a wedge shape, or may be formed in a three-dimensional shape such as a partially spherical surface or an uneven shape.

Examples of the substrate 13 include synthetic resin, fiber reinforced plastics (FRP), carbon, and glass. The synthetic resin may be, for example, one or more resins selected from the group consisting of polyethylene terephthalate (PET), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resin, ABS resin, acrylic resin, fluororesin, nylon resin, polyacetal resin, polycarbonate resin, polyamide resin, and polyurethane resin. The substrate may be a composite material of these synthetic resins. The substrate 13 in the present embodiment is formed of a PET sheet.

The thickness L2 of the substrate 13 is, for example, preferably 15 μm or more, more preferably 20 μm or more, and even more preferably 25 μm or more. The upper limit of the thickness L2 of the substrate 13 is, for example, preferably 200 μm or less, more preferably 150 μm or less, and even more preferably 125 μm or less.

The substrate 13 preferably has flexibility. The substrate 13 preferably has a higher longitudinal elastic modulus than the protective layer 15. The longitudinal elastic modulus of the substrate 13 is, for example, preferably 1 GPa or more, more preferably 1.2 GPa or more, and even more preferably 1.5 GPa or more. The upper limit of the longitudinal elastic modulus of the substrate 13 is, for example, preferably 4 GPa or less, more preferably 3.8 GPa or less, and even more preferably 3.5 GPa or less (electric conductor 12).

The electric conductor 12 reflects radio waves. The electric conductor 12 is formed on the upper surface of the substrate 13. The electric conductor 12 is formed by using, for example, wet etching or dry etching. Examples of wet etching include screen printing, photolithography, and offset printing. Examples of dry etching include reactive gas etching, reactive ion etching, reactive ion beam etching, ion beam etching, and reactive laser beam etching.

The electric conductor 12 may also be formed in the form of a thin film embedded in resin. For example, after an electric conductor film is formed, a pattern may be formed by etching, and the patterned thin conductive film may be extracted. Alternatively, a photosensitive resist may be applied onto a base film provided with a lift-off layer, and a pattern may be formed by photolithography. After the patterned portion is filled with an electric conductor, the patterned thin conductive film is extracted. The electric conductor 12 may have a thin metal film adhered or have a metal deposited.

When the electric conductor 12 for use is in a thin-film form, a thin film containing the electric conductor 12 (conductive film layer) is stacked on the substrate 13 to form the conductive layer 16.

The electric conductor 12 may be, for example, one or more of the following: silver, gold, copper, platinum, aluminum, titanium, silicone, indium tin oxide, and alloys (e.g., alloy containing nickel, chromium, and molybdenum). Examples of alloys containing nickel, chromium, and molybdenum include various grades of alloys, such as Hastelloy B-2, B-3, C-4, C-2000, C-22, C-276, G-30, N, W, and X.

The thickness L3 of the electric conductor 12 is preferably 5 nm or more, and more preferably 0.05 μm or more. The upper limit of the thickness L3 of the electric conductor 12 is preferably 10 μm or less. The electric conductor 12 with a thickness L3 of 5 nm or more ensures appropriate radio wave intensity.

The conductive layer 16 preferably has a coverage of 1% or more and 50% or less, and more preferably 1% or more and 10% or less. The coverage refers to the percentage of the area occupied by the electric conductor 12 per unit area in a region in which the electric conductor 12 is present on the upper surface of the substrate 13 in a plan view. The region in which the electric conductor 12 is present is the region defined by excluding the peripheral portion of the substrate 13 from the upper surface of the substrate 13 (the portion between the edge 13a of the substrate 13 and the electric conductor 12). The coverage is measured with, for example, a scanning electron microscope (SEM), a transmission electron microscope (TEM), or an optical microscope.

As shown in FIG. 3(B), the pattern of the electric conductor 12 is composed of a plurality of regions in which the electric conductor 12 is not present (which may be referred to as “first regions 12a”) and the electric conductor 12 surrounding the first regions 12a. The first regions 12a may be filled with an adhesive layer, described below, or may be filled with a resin that forms the conductive layer 16. The first regions 12a are formed in the same shape, which is a square shape in the present embodiment; however, the first regions 12a may be rectangular. The first regions 12a of the same shape are arranged at a regular interval.

The electric conductor 12 according to the present embodiment is explained in more detail below. The first regions 12a are each surrounded by a rectangular electric conductor 12 formed of two parallel first lines 12A and two parallel second lines 12B. The first line 12A and the second line 12B are perpendicular to each other.

Common lines 12A and 12B are present between adjacent first regions 12a. The first lines 12A and the second lines 12B are electrically connected at their intersections. The width L6 of the lines is preferably set to 0.05 μm or more and 15 μm or less.

The maximum length L7 between the edges in the first regions 12a, or the distance L8 between the adjacent first lines 12A or the adjacent second lines 12B, is set to be greater than the wavelength of visible light and smaller than the wavelength of radio waves reflected by the radio wave reflector 11. The maximum length of the sides of the first regions 12a is preferably set to 2 μm or more and 10 cm or less, more preferably 20 μm or more and 1 cm or less, even more preferably 25 μm or more and 1 mm or less, and still more preferably 30 μm or more and 250 μm or less. This allows the maximum length L7 to be greater than the wavelength of visible light and smaller than the wavelength of radio waves reflected by the radio wave reflector 11.

The thickness of the conductive layer 16 (L2+L3) is dominated by the thickness of the substrate 13. The thickness of the conductive layer (L2+L3) is, for example, preferably 0.1 μm or more, more preferably 0.2 μm or more, and even more preferably 0.3 μm or more. The upper limit of the thickness of the conductive layer (L2+L3) is, for example, preferably 20 μm or less, more preferably 15 μm or less, and even more preferably 10 μm or less.

The arrangement of the electric conductor 12 at the end portion of the radio wave reflector 11 is described in detail below.

### Variation Examples of Pattern of Electric Conductor 12

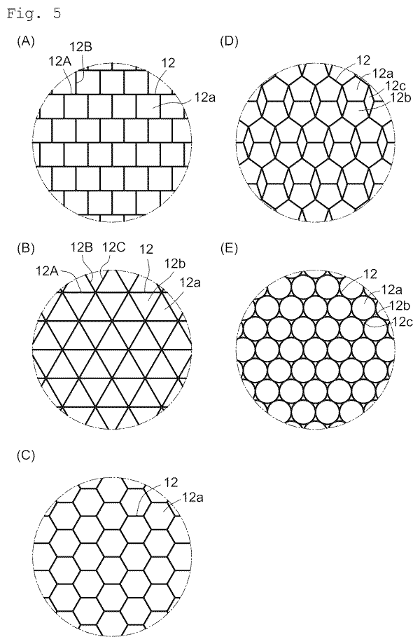

The pattern of the electric conductor 12 is not limited to a grid pattern as shown in the embodiment. For example, the electric conductor 12 may be of any pattern shown in FIGS. 5(A) to 5(E). For explanation purposes, FIGS. 5(A) to 5(E) show only the electric conductor 12. The rest of the structure of the electric conductor 12 is the same as that shown in FIG. 3(B).

In one variation example, the electric conductor 12 may be of a brickwork pattern, as shown in FIG. 5(A). Specifically, a plurality of the first lines 12A are arranged in a line in the horizontal direction, and the first lines 12A arranged in a line are spaced apart in the vertical direction. The second lines 12B connect the vertically adjacent first lines 12A to each other, and the vertically adjacent second lines 12B are shifted from each other.

In one variation example, the electric conductor 12 may be of a triangular pattern, as shown in FIG. 5(B). In this variation example, triangular first regions 12a and inverted triangular second regions 12b are present as a plurality of regions not containing the electric conductor 12. The second regions 12b are disposed between the adjacent first regions 12a. Each of the first regions 12a and the second regions 12b is surrounded by a first line 12A, a second line 12B, and a third line 12C. The first regions 12a are arranged at a regular interval in the horizontal and vertical directions. The second regions 12b are also arranged at a regular interval in the horizontal and vertical directions. Additionally, the shape formed by the first region 12a and the second region 12b is repeatedly arranged in the same period.

Although the shape of each of the regions 12a and 12b is an equilateral triangle, the shape may be, for example, an isosceles triangle or a triangle with three sides of different lengths.

In one variation example, as shown in FIG. 5(C), the first regions 12a may be of a regular hexagon surrounded by a linear electric conductor 12. The first regions 12a are arranged at a regular interval in the vertical and horizontal directions.

In one variation example, as shown in FIG. 5(D), a plurality of regions of different shapes not containing the electric conductor 12 may be present. Specifically, in one variation example, first regions 12a in the shape of a regular pentagon, second regions 12b in the shape of an inverted regular pentagon, and third regions 12c in the shape of a rhombus, each surrounded by the linear electric conductor 12, are present as regions not containing the electric conductor 12. The first regions 12a are arranged at a regular interval in the horizontal and vertical directions. The second regions 12b are also arranged at a regular interval in the horizontal and vertical directions. The third regions 12c are also arranged at a regular interval in the horizontal and vertical directions. Moreover, the shape formed by the first region 12a, the shape formed by the second region 12b, and the shape formed by the third region 12c are arranged with the same period.

In one variation example, the electric conductor 12 may be of a pattern as shown in FIG. 5(E). Specifically, circular first regions 12a, substantially triangular second regions 12b, and substantially inverted triangular third regions 12c, each surrounded by the linear electric conductor 12, may be present as regions not containing the electric conductor 12.

### Adhesive Layer 14

The adhesive layer 14 is provided between the conductive layer 16 and the protective layer 15 to bond the conductive layer 16 and the protective layer 15. The adhesive layer 14 is preferably formed over the entire surface between the conductive layer 16 and the protective layer 15, but may also be formed only partially between the conductive layer 16 and the protective layer 15. The adhesive layer 14 may be, for example, a synthetic resin or a rubber adhesive sheet. Examples of synthetic resins include acrylic resins, silicone resins, and polyvinyl alcohol resins. The adhesive layer 14 may be formed by filling the space between the conductive layer and the protective layer with a fluid adhesive and then curing the adhesive, or by an adhesive sheet with an adhesive surface disposed between the conductive layer 16 and the protective layer 15.

The thickness L4 of the adhesive layer 14 is preferably 5 μm or more, more preferably 10 μm or more, and even more preferably 15 μm or more. The upper limit of the thickness L4 of the adhesive layer 14 is preferably 150 m or less, more preferably 125 μm or less, and even more preferably 100 μm or less.

The adhesive layer 14 preferably has a hydroxyl value of 5 mg KOH/g or more, more preferably 8 mg KOH/g or more, even more preferably 30 mg KOH/g or more, and still more preferably 90 mg KOH/g or more. The upper limit of the hydroxyl value of the adhesive layer 14 is preferably 120 mg KOH/g or less. A hydroxyl value of the adhesive layer 14 being 5 mg KOH/g or more is advantageous in that the adhesive layer 14 is less likely to foam and/or whiten in a high-temperature and high-humidity environment. In the present specification, the hydroxyl value is measured according to a test method conforming to JIS K 1557.

The acid value of the adhesive layer 14 is preferably 50 mg KOH/g or less, more preferably 45 mg KOH/g or less, even more preferably 30 mg KOH/g or less, and still more preferably 10 mg KOH/g or less. The lower limit of the acid value of the adhesive layer 14 is preferably 0.1 mg KOH/g or more. An acid value of the adhesive layer 14 being 50 mg KOH/g or less protects the electric conductor 12 from corrosion and increases the stability of radio wave reflectivity over time. In the present specification, the acid value is measured according to a test method conforming to JIS K 2501.

The adhesive layer 14 preferably does not contain a UV inhibitor. The adhesive layer 14 not containing a UV inhibitor is advantageous in that the adhesive layer 14 can be easily adjusted to be colorless and transparent. The phrase “not contain” or “not containing” as used herein includes not only the case in which the adhesive layer 14 does not contain a UV inhibitor at all, but also the case in which the adhesive layer 14 contains a slight amount of a UV inhibitor to the extent that the adhesive layer 14 does not lose its colorless transparency. A UV inhibitor absorbs or scatters ultraviolet rays to prevent the penetration of the rays, and may be either a UV absorber or a UV-scattering agent.

The adhesive layer 14 is preferably made of a material with a dielectric loss tangent (tan 5) of 0.018 or less. A lower dielectric loss tangent is better. The lower limit of the dielectric loss tangent is, for example, 0.0001 or more. Using the adhesive layer 14 with a dielectric loss tangent of 0.018 or less reduces the loss of electrical energy of the radio waves in the radio wave reflector 11 and further increases reflection intensity.

It is also preferred that the synthetic resin material of the adhesive layer 14 has a relative permittivity that changes according to the frequency of an electric field. The relative permittivity is the ratio of the permittivity of a medium (a synthetic resin material in the present embodiment) to the permittivity of a vacuum. Changes in the relative permittivity according to an electric field make it possible to increase the intensity of a reflected wave in an electric field of a specific frequency. The relative permittivity preferably changes in the range of 1.5 or more and 7 or less, and more preferably 1.8 or more and 6.5 or less.

The adhesive layer 14 is preferably made of a synthetic resin material with a dielectric loss tangent (tan 6) of 0.018 or less. A lower dielectric loss tangent is better, but the dielectric loss tangent is typically 0.0001 or more. The dielectric loss tangent indicates the degree of electrical energy loss within a dielectric. The electrical energy loss is greater in a material with a greater dielectric loss tangent. Using the adhesive layer 14 with a dielectric loss tangent of 0.018 or less reduces the loss of electrical energy of radio waves in the radio wave reflector 11, and further increases reflection intensity.

### Protective Layer 15

The protective layer 15 covers at least one surface of the conductive layer 16 to protect the conductive layer 16. The protective layer 15 according to the present embodiment has a size corresponding to that of the substrate 13 in a plan view. The protective layer 15 may be, for example, a sheet (film) made of a synthetic resin. The synthetic resin may be, for example, one or more members selected from the group consisting of polyethylene terephthalate (PET), cycloolefin polymer (COP), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resin, ABS resin, acrylic resin, fluororesin, nylon resin, polyacetal resin, polycarbonate resin, polyamide resin, and polyurethane resin.

The thickness L5 of the protective layer 15 is preferably 20 μm or more, more preferably 38 μm or more, and even more preferably 50 μm or more. The upper limit of the thickness L5 of the protective layer 15 is preferably 200 μm or less, and more preferably 150 μm or less.

A pencil hardness test performed on only the protective layer 15 results in a pencil hardness of preferably 4B or higher, more preferably B or higher, and even more preferably F or higher under a surface load of 500 g on the protective layer 15. The protective layer 15 with a pencil hardness of 4B or higher in a pencil hardness test performed only on the protective layer 15 can protect the electric conductor 12. The protective layer 15 with a pencil hardness of F or higher in a pencil hardness test performed only on the protective layer 15 can provide stronger protection for the electric conductor 12.

The protective layer 15 has a moisture permeability of preferably 20 g/m²·24 h or less, more preferably 16 g/m²·24 h or less, even more preferably 12 g/m²·24 h or less, and still more preferably 10 g/m²·24 h or less, at a temperature of 40 °C and a humidity 90% RH (relative humidity). The protective layer 15 with a moisture permeability of 20 g/m²·24 h or less at a temperature of 40 °C and a humidity of 90% RH (relative humidity) is advantageous in that the conductive layer 16 is less susceptible to corrosion and less likely to undergo an increase in surface resistivity. The “moisture permeability” as used in the present specification is measured according to a test method conforming to JIS Z 0208 (1976).

The protective layer 15 preferably has flexibility. The protective layer 15 has a longitudinal elastic modulus of, for example, preferably 1 GPa or more, more preferably 1.2 GPa or more, and even more preferably 1.5 GPa or more. The upper limit of the longitudinal elastic modulus of the protective layer 15 is, for example, preferably 4 GPa or less, more preferably 3.8 GPa or less, and even more preferably 3.5 GPa or less.

The protective layer 15 may be subjected to anti-glare treatment or anti-reflection treatment. For example, if the protective layer 15 is formed of a film, anti-glare treatment or anti-reflection treatment may be applied to at least either the upper surface (front surface) or the lower surface (the surface facing the adhesive layer 14), or both films.

The anti-glare treatment refers to a treatment in which an uneven pattern is formed on at least one surface of the protective layer 15 to scatter light, thereby suppressing glare from a light source, such as lighting, on the protective layer 15. Examples of methods for performing anti-glare treatment include a method in which a binder resin having fine particles dispersed therein is applied to the surface of a film, sandblasting, and chemical etching.

The anti-reflection treatment refers to a treatment in which an anti-reflection film is formed on at least one surface of the protective layer 15, and light reflected from the surface of the anti-reflection film and light reflected from the interface between the anti-reflection film and a film are attenuated through interference, thereby suppressing glare from a light sources, such as lighting. The anti-reflection film may be a single layer or a laminate of alternating thin films with different refractive indices.

The protective layer 15 may be formed of a synthetic resin film and a film that has been subjected to anti-glare treatment or anti-reflection treatment and that is adhered to one or both sides the synthetic resin film.

The protective layer 15 may contain a UV inhibitor or have the upper surface (front surface) treated to block UV. Alternatively, the protective layer 15 may contain a UV inhibitor and have also been treated to block TUV. The UV blocking treatment means a treatment to form a film containing a UV inhibitor by coating or the like. This configuration makes it less likely for ultraviolet rays to penetrate into the interior of the radio wave reflector 11, and so discoloration of the radio wave reflector 11 due to ultraviolet rays can be suppressed even when the radio wave reflector 11 is used for a long period of time. As described above, the UV inhibitor may be either a UW absorber or a UV-scattering agent. Examples of IV absorbers include ethylhexyl methoxycinnamate, t-butyl methoxydibenzoylmethane, and dimethyl PABA octyl. Examples of UV-scattering agents include titanium oxide and zinc oxide. However, the LW inhibitor is not limited to these.

### Structure of End Portion of Radio Wave Reflector 11

The structure of the peripheral portion of the radio wave reflector 11 is described in detail below. All of the electric conductors 12 constituting the conductive layer 16 are formed on the upper surface of the substrate 13. The electric conductors 12 are preferably positioned at least 5 mm medially from the edge of the laminate 18. The edge of the laminate 18 refers to the edge 13a of the substrate 13, which is part of the laminate 18. If the substrate 13 has the same size as that of the protective layer 15 and the adhesive layer 14, the edge can also be considered to be the respective edges of the protective layer 15 and the adhesive layer 14. As shown in FIG. 4, in a plan view, it is preferred that the distance L11 between a predetermined position P1 on the edge of the laminate 18 (the edge 13a of the substrate 13) and the electric conductor 12 closest to the predetermined position P1 be set to at least 5 mm. In a plan view, the electric conductors 12 are covered by supporting layers, such as the substrate 13, the adhesive layer 14, and the protective layer 15.

Furthermore, since the electric conductor 12 is not disposed at the end portion including the edge of the laminate 18, the end portion including the edge of the laminate 18 has the structure in which the adhesive layer 14 and the protective layer 15 are stacked on the upper surface of the substrate 13. Thus, in a lateral view, the electric conductors 12 are covered by these layers. The electric conductors 12 in the present embodiment are therefore not exposed to the outside.

Specifically, the electric conductor 12 being “not exposed to the outside” means that the electric conductor 12 is covered by supporting layers, such as the substrate 13, the adhesive layer 14, and the protective layer 15, when viewed from the top and side.

As in the present embodiment, if the radio wave reflector 11 is formed of the laminate 18 and does not include a sealant 17, described below, the phrase “not exposed to the outside” means that the electric conductor 12 is positioned medially from the edge of the laminate 18 (the edge 13a of the substrate 13) and is covered by supporting layers, such as the substrate 13, the adhesive layer 14, and the protective layer 15, when viewed from the top and side.

Generally, the radio wave reflector 11 deteriorates due to discoloration, corrosion, and the like caused by the environmental influence. The structure described above does not expose the electric conductor 12 to the outside and thus makes the electric conductor 12 less susceptible to the influence of the environment, thereby preventing the radio wave reflector 11 from deterioration to ensure durability.

### Variation Example of Structure of End Portion of Radio Wave Reflector 11

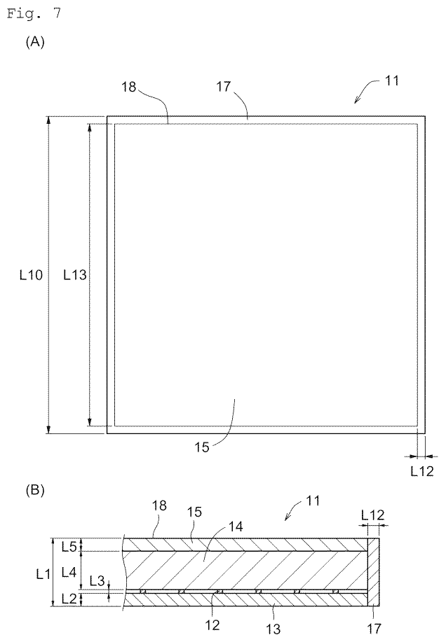

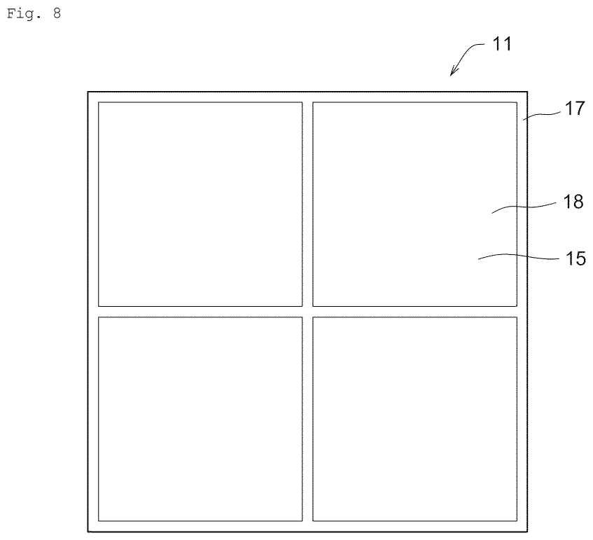

FIGS. 7(A) and 7(B) show variation examples of the structure of the end portion. The radio wave reflector 11 in the present embodiment contains a sealant 17 that covers the side of the laminate 18 in the position that is around the laminate 18 and that at least corresponds to the electric conductors 12 that constitute the conductive layer 16. The sealant 17 needs to cover only the side of the laminate 18 so that at least the electric conductors 12 are not exposed to the outside when viewed from the lateral side of the radio wave reflector 11, and may cover the side of the substrate 13, the conductive layer 16, the adhesive layer 14, and the protective layer 15, as shown in FIG. 7 (B). The sealant 17 has adhesive properties and is adhered to the side of each layer.

In the present embodiment, in a plan view, the electric conductors 12 may be disposed on the substrate 13 at a position aligned with the edge 13a of the substrate 13, and may be provided continuously along the edge 13a of the substrate 13. Specifically, in a plan view, the distance L11 between a predetermined position P1 on the edge of the laminate 18 (the edge 13a of the substrate 13) and the electric conductor 12 closest to the predetermined position P1 may be zero.

The electric conductor 12 is disposed medially from the edge of the radio wave reflector 11 at least by the amount of the sealant 17 in a plan view. The sealant 17 is in contact with at least the side of the electric conductor 12 to prevent exposure of the electric conductor 12 to the outside. The sealant 17 makes the electric conductor 12 less susceptible to environmental influence and prevents deterioration of the radio wave reflector 11 to ensure its durability.

The electric conductor 12 may be formed inside from the edge 13a of the substrate 13. In this case, the electric conductor 12 is located inside from the edge 13a of the substrate 13, and additionally, the sealant 17 makes the electric conductor 12 even less susceptible to environmental influence. This prevents deterioration and ensures durability.

The electric conductor 12 may be formed inside from the edge 13a of the substrate 13. In this case, the electric conductor 12 is located inside from the edge 13a of the substrate 13, and additionally, the sealant 17 makes the electric conductor 12 even less susceptible to environmental influence. This prevents deterioration and ensures durability.

In other words, the electric conductor 12 being “not exposed to the outside” in the present embodiment shown in FIG. 7 means that the electric conductor 12 is covered by the sealant 17 when the radio wave reflector 11 is viewed from the lateral side, and the electric conductor 12 is covered by the substrate 13, the adhesive layer 14, and the protective layer 15 when viewed from the top.

The length L12 (the width of the sealant 17) over which the sealant 17 protrudes from the laminate 18 in a plan view is constant and is preferably 0.01 mm or more and 10 mm or less. The length L10 of one side of the radio wave reflector 11 is determined by adding twice the protruding length L12 of the sealant 17 to the length L13 of one side of the laminate 18.

For the sealant 17, a synthetic resin is used. Examples of synthetic resins include silicone resin, epoxy resin, polyester resin, acrylic resin, urethane resin, polyimide resin, polyvinyl chloride resin, and nylon resin.

Because the rest of the structure and operation are similar to those of the embodiment shown in FIGS. 2 to 4, the same reference numerals are used to designate corresponding elements, and detailed description for the elements is omitted.

### Method for Producing Radio Wave Reflector 11 of Embodiment in Which Sealant 17 is Provided

The radio wave reflector 11 in the embodiment shown in FIG. 7 may be produced as a radio wave reflector 11 first and then attached to an installation site, such as on a wall. The production method for the radio wave reflector 11 is as follows. First, the step of forming the laminate 18 is performed. In this step, the conductive layer 16 is formed on the upper surface of the substrate 13, and the protective layer 15 is adhered onto the conductive layer 16 via the adhesive layer 14, thereby forming the laminate 18. Second, the step of providing the sealant 17 is performed. In this step, the sealant 17 is provided around the laminate 18, at least in a position corresponding to the electric conductor layer 16 so as to not expose the electric conductor 12. The sealant 17 has adhesive properties and is thus attached to the side of the laminate 18. Through these steps, the radio wave reflector 11 of the embodiment shown in FIG. 7 is produced.

Alternatively, the step of providing the sealant 17 may be performed first, and then the step of forming the laminate 18 may be performed. In the step of providing the sealant 17, the sealant 17 is disposed in an annular shape on the surface of, for example, release paper. The space surrounded by the sealant 17 has the same shape and size as those of the laminate 18 in a plan view. Next, the step of forming the laminate 18 is performed as described above. Then, the step of setting the laminate 18 in the space surrounded by the sealant 17 is performed. In this manner, the radio wave reflector 11 is produced. In the thus-produced radio wave reflector 11, the sealant 17 is located around the laminate 18 in a position corresponding to at least the conductive layer 16.

### Method of Installing Radio Wave Reflector 11 of Embodiment in Which Sealant 17 is Provided

The radio wave reflector 11 in the embodiment shown in FIG. 7 may be attached to an installation site on an installation surface, such as a wall, according to the following installation method. The installation site is, for example, a surface such as of a building wall, a partition, a pillar, a lintel, an exterior wall of a building, or a window, and may be a flat surface or a curved surface. First, the step of attaching the laminate 18 to an installation site is performed. In this step, the laminate 18 is attached to an installation site by using an attachment means, such as double-sided tape or an adhesive, so that the substrate 13 is in contact with the installation site. Second, the step of providing the sealant 17 is performed. In this step, the sealant 17 is provided around the laminate 18 at least in a position corresponding to the electric conductor layer 16 so as to not expose the electric conductor 12.

Alternatively, the step of providing the sealant 17 may be performed first, and then the step of attaching the laminate 18 to an installation site may be performed. First, the sealant 17 is provided in an annular shape around the site on the installation surface, such as a wall, where the laminate 18 is to be installed. Second, the laminate 18 is attached to the installation site so as to be set in the space surrounded by the sealant 17. In this manner, the radio wave reflector 11 is installed at the installation site.

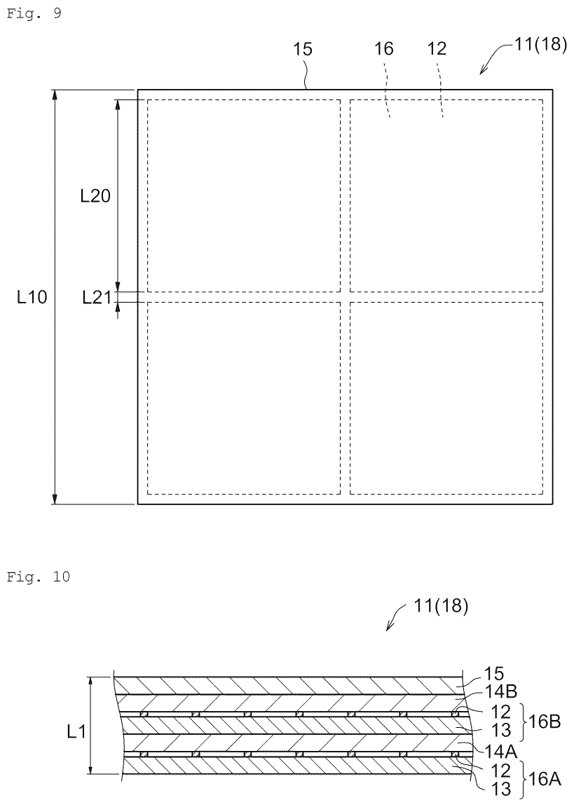

In the embodiment shown in FIG. 7, the radio wave reflector 11 includes a single laminate 18. However, the radio wave reflector 11 may include a plurality of laminates 18 spaced apart. In the example shown in FIG. 8, four laminates 18 are arranged. In a plan view, the sealant 17 is provided on the sides that have no adjacent laminate 18, among the four sides of each laminate 18, and the entire space between adjacent laminates 18 is filled with the sealant 17. Accordingly, the sealant 17 is disposed around each of the laminates 18. The method for installing such a radio wave reflector 11 is as follows. First, the step of attaching a plurality of laminates 18 at an interval to an installation site, such as a wall, by using an attachment means, such as double-sided tape or an adhesive, is performed. Second, the step of providing the sealant 17 is performed. In this step, the sealant 17 is provided at least in a position corresponding to the conductive layer, on the sides that have no adjacent laminate 18, among the four sides of each laminate 18. Then, the sealant 17 is provided in the entire space between adjacent laminates 18. In this manner, the radio wave reflector 11 is installed on the installation site. Alternatively, the step of providing the sealant 17 may be performed first, and then the step of attaching the laminates 18 to an installation site may be performed. First, the sealant 17 is provided in an annular shape around the area in which a plurality of laminates 18 are to be installed. Further, the sealant 17 is provided in the space that will be formed between adjacent laminates 18 to be attached at an interval on the installation site. Second, the laminates 18 are attached to the installation site so as to be set in the space surrounded by the sealant 17.

### Method for Use

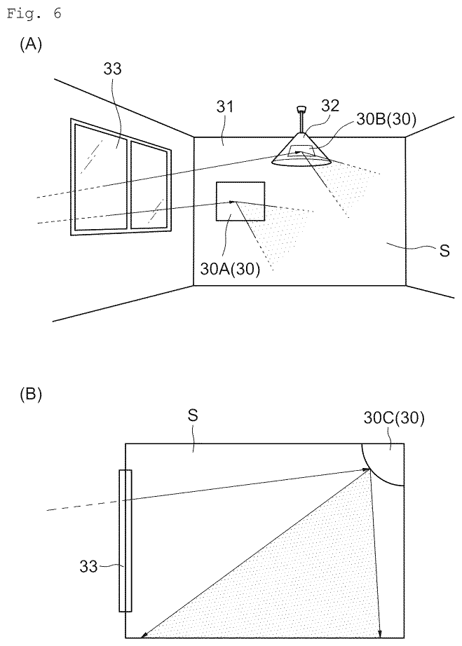

The radio wave reflector 11 according to the embodiment above may be attached to the installation site, such as the surface of a building wall, a partition, a pillar, a lintel, an exterior wall of a building, or a window, by using an adhesive or the like for use. Additionally, the radio wave reflector 11 may be used as, for example, an interior paper or decorative material. The interior paper is a paper material attached to the inner surface of the interior material. Examples of interior materials include inner walls, ceiling panels, partitions, and flooring materials. Examples of decorative materials include posters, decorative stickers, and stained-glass-style stickers. Decorative materials include wall materials, flooring materials, doors, lighting covers, transoms, pillars, televisions, and desk tops. FIG. 6 shows an example in which a poster is put up on a wall surface as a decorative material 30A, and a decorative material 30B is attached to a lighting cover.

The decorative materials 30A and 30B, which include the radio wave reflector 11 attached to indoor equipment or building materials, reflect radio waves entering the room from the outdoor through a window 33 or the like. This allows radio waves to reach a wider area in indoor space S, improving the convenience of radio wave reception.

The application of the radio wave reflector 11 is not limited to wallpaper. The radio wave reflector 11 may also be used in, for example, printing paper for printed plywood. In this case, plywood including the radio wave reflector 11 may be used to form doors, walls, partitions, exterior wall materials, roofs, ceiling panels, flooring materials, baseboards, or the like.

The radio wave reflector 11 can be used not only on a flat surface but also on a spherical surface. For example, FIG. 6(B) is a plan view of the interior of a room. The building material 30, having the radio wave reflector 11 on its surface, is a corner pillar 30C with a spherical surface at the corner of the room. Radio waves entering through the window 33 are reflected by the corner pillar 30C and spread over a wider range in the indoor space S. Note that FIGS. 6(A) and 6(B) are merely diagrams showing emitted waves, and do not show the actual range of reflection of radio waves.

### Evaluation Test A

The radio wave reflector 11 was produced in Examples 1 to 13 and also in Comparative Examples 1 to 8. A pencil hardness test and evaluation tests for adhesion of the protective layer to the adherend layer, radio wave reflectivity, total light transmittance, haze, surface resistivity, foaming, whitening, yellowness Δb*, etc. were performed. However, the radio wave reflector 11 of the present invention is not limited to those in Examples 1 to 13.

### EXPLANATION OF EXAMPLES AND COMPARATIVE EXAMPLES

In Examples 1 to 13 and Comparative Examples 1 to 8, test specimens were produced as follows. One part of a crosslinking agent was added to 100 parts of the adhesive described below, and the mixture was stirred for 3 minutes to obtain an adhesive composition. Subsequently, a protective layer was laid on a coating table, and the adhesive composition was added dropwise thereto, while a coater adjusted to a thickness of 25 μm was moved, thereby obtaining an adhesive layer. The obtained layer was dried at a temperature of 110 °C for 5 minutes and then cured with heating at 40 °C for 48 hours, thereby obtaining a protective layer and an adhesive layer for use in a test specimen.

Then, a conductive layer and the protective layer and adhesive layer produced above were laminated in vacuum at 40 °C for 6 minutes to obtain a test specimen. Note that under the following conditions, for test specimens not containing an adhesive layer and a protective layer, the step of obtaining a protective layer and an adhesive layer was not performed.

### (1) Example 1

In Example 1, the conditions of the test specimen described above were the following.

### Conductive Layer

Shape: Square with each side having a length of 20 cm
Material: PET sheet
Electric Conductor: Grid pattern made of silver (Ag), line width: 0.8 μm, line thickness: 0.5 μm, grating pitch: 30 μm
   (The grid pattern refers to a grid pattern in which the regions 12a that contain no electric conductor, each surrounded by the electric conductor 12, have a square shape (the pattern of the electric conductors 12 shown in FIG. 3(B)). The grating pitch refers to the distance L8 between adjacent parallel electric conductors 12 in the grid pattern.)

### Adhesive Layer

Adhesive: X313-295S-14 (manufactured by Saiden Chemical Industry Co., Ltd.)
Acid value: 0.8 mg KOH/g
Hydroxyl value: 115 mg KOH/g
Crosslinking agent: L-45K (manufactured by Soken Chemical & Engineering Co., Ltd.) Isocyanate-based

### Protective Layer

Material: PET sheet
Thickness: 125 μm
Pencil hardness test (protective layer only): F
Moisture permeability: 4.8 g/m²·24 h

### (2) Example 2

In Example 2, the conditions of the test specimen described above were the following.

### Conductive Layer

Shape: Square with each side having a length of 20 an
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 125 μm
Pencil hardness test (protective layer only): F
Moisture permeability: 4.8 g/m²·24 h

### (3) Example 3

In Example 3, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2006HE (manufactured by Soken Chemical & Engineering Co., Ltd.)
Acid value: 30 mg KOH/g
Hydroxyl value: 10 mg KOH/g
Crosslinking agent: L-45K (manufactured by Soken Chemical & Engineering Co., Ltd.) Isocyanate-based

### Protective Layer

Material: PET sheet
Thickness: 125 μm
Pencil hardness test (protective layer only): F
Moisture permeability: 4.8 g/m²·24 h

### (4) Example 4

In Example 4, the conditions of the test specimen described above were the following.

### Conductive Layer

Shape: Square with each side having a length of 20 am
Material: PET sheet
Electric conductor: grid pattern made of silver (Ag), line width: 0.8 μm, line thickness: 0.5 μm, grating pitch: 30 μm

### Adhesive Layer

Adhesive: 2137KH (manufactured by Soken Chemical & Engineering Co., Ltd.)
Acid value: 10 mg KOH/g
Hydroxyl value: 8.0 mg KOH/g
Crosslinking agent: L-45K (manufactured by Soken Chemical & Engineering Co., Ltd.) Isocyanate-based

### Protective Layer

Material: PET sheet
Thickness: 125 μm
Pencil hardness test (protective layer only): F
Moisture permeability: 4.8 g/m²·24 h

### (5) Example 5

In Example 5, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 75 μm
Pencil hardness test (protective layer only): F
Moisture permeability: 8.0 g/m²·24 h

### (6) Example 6

In Example 6, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 50 μm
Pencil hardness test (protective layer only): F
Moisture permeability: 12 g/m²·24 h

### (7) Example 7

In Example 7, the conditions of the test specimen described above were the following.

### Conductive Layer

Shape: Square with each side having a length of 20 an
Material: PET sheet
Electric conductor: grid pattern made of silver (Ag), line width: 0.8 μm, line thickness: 0.5 μm, grating pitch: 45 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 125 μm
Pencil hardness test (protective layer only): F
Moisture permeability: 4.8 g/m²·24 h

### (8) Example 8

In Example 8, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 1604N (manufactured by Soken Chemical & Engineering Co., Ltd.)
Acid value: 45 mg KOH/g
Hydroxyl value: 6.6 mg KOH/g
Crosslinking agent: L-45K (manufactured by Soken Chemical & Engineering Co., Ltd.) Isocyanate-based

### Protective Layer

Material: PET sheet
Thickness: 125 μm
Pencil hardness test (protective layer only): F
Moisture permeability: 4.8 g/m²·24 h

### (9) Example 9

In Example 9, the conditions of the test specimen described above were the following.

### Conductive Layer

Shape: Square with each side having a length of 20 am
Material: PET sheet
Electric conductor: grid pattern made of silver (Ag), line width: 0.8 μm, line thickness: 0.5 μm, grating pitch: 30 μm

### Adhesive Layer

Adhesive: 1502C (manufactured by Soken Chemical & Engineering Co., Ltd.)
Acid value: 0.1 mg KOH/g
Hydroxyl value: 8.8 mg KOH/g
Crosslinking agent: E-AX (manufactured by Soken Chemical & Engineering Co., Ltd.) Epoxy type

### Protective Layer

Material: PET sheet
Thickness: 125 μm
Pencil hardness test (protective layer only): F
Moisture permeability: 4.8 g/m²·24 h

### (10) Example 10

In Example 10, the conditions of the test specimen were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2147 (manufactured by Soken Chemical & Engineering Co., Ltd.)
Acid value: 4.0 mg KOH/g
Hydroxyl value: 32 mg KOH/g
Crosslinking agent: L-45K (manufactured by Soken Chemical & Engineering Co., Ltd.) Isocyanate-based

### Protective Layer

Material: PET sheet
Thickness: 125 μm
Pencil hardness test (protective layer only): F
Moisture permeability: 4.8 g/m²·24 h

### (11) Example 11

In Example 11, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet (KB125N05 manufactured by KIMOTO Co., Ltd.)
Thickness: 125 μm
Pencil hardness test (protective layer only): 3H
Moisture permeability: 4.8 g/m²·24 h

### (12) Example 12

In Example 12, the conditions of the test specimen described above were the following.

### Conductive Layer

Shape: Square with each side having a length of 20 an
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 38 μm
Pencil hardness test (protective layer only): F
Moisture permeability: 16 g/m²·24 h

### (13) Example 13

In Example 13, the conditions of the test specimen described above were the following.

### Conductive Layer

Shape: Square with each side having a length of 20 cm
Material: PET sheet
Electric conductor: grid and circular pattern made of copper (Cu), line width: 2.3 μm, line thickness: 1.6 μm, grating pitch: 100 μm

(The grid and circular pattern means that the regions 12a containing no electric conductor, each surrounded by the electric conductor 12, include both regions 12a in a square pattern and regions 12a in a circular pattern, and refer to the pattern shown in variation example 4 (FIG. 12), described below. The grating pitch refers to the distance L8 between adjacent parallel electric conductors 12 surrounding a square region 12a (first enclosed section 41 in FIG. 12), and the diameter of the electric conductors 12 formed in a circle shape (second enclosed section 51 in FIG. 12) is equal to the grating pitch.)

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet (TOYOBOESTER film HB3UO)
Thickness: 50 μm
Pencil hardness test (protective layer only): 3H
Moisture permeability: 4.8 g/m²·24 h

### (14) Comparative Example 1

In Comparative Example 1, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer and Protective Layer

None

### (15) Comparative Example 2

In Comparative Example 2, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 45 μm

### Adhesive Layer, Protective Layer

None

### (16) Comparative Example 3

In Comparative Example 3, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 38 μm
Pencil hardness test (protective layer only): F
Moisture permeability: 16 g/m²·24 h

### (17) Comparative Example 4

In Comparative Example 4, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 38 μm
Pencil hardness test (protective layer only): F
Moisture permeability: 16 g/m²·24 h

### (18) Comparative Example 5

In Comparative Example 5, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 25 μm
Pencil hardness test (protective layer only): F
Moisture permeability: 24 g/m=−24 h

### (19) Comparative Example 6

In Comparative Example 6, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PET sheet
Thickness: 25 μm
Pencil hardness test (protective layer only): F
Moisture permeability: 24 g/m²·24 h

### (20) Comparative Example 7

In Comparative Example 7, the conditions of the test specimen described above were the following.

### Conductive Layer

Shape: Square with each side having a length of 20 cm
Material: PET sheet
Electric Conductor: grid pattern made of silver (Ag), line width: 0.8 μm, line thickness: 0.5 μm, grating pitch: 30 μm Adhesive layer
Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: PP sheet
Thickness: 50 μm
Pencil hardness test (protective layer only): B
Moisture permeability: 4.5 g/m²·24 h

### (21) Comparative Example 8

In Comparative Example 8, the conditions of the test specimen described above were the following.

### Conductive Layer

Shape: Square with each side having a length of 20 cm
Material: PET sheet
Electric conductor: grid pattern made of silver (Ag), line width: 0.8 μm, line thickness: 0.5 μm, grating pitch: 30 μm

### Adhesive Layer

Adhesive: 2980 (manufactured by Soken Chemical & Engineering Co., Ltd.)
Acid value: 0.5 mg KOH/g
Hydroxyl value: 95 mg KOH/g
Crosslinking agent: L-45K (manufactured by Soken Chemical & Engineering Co., Ltd.) Isocyanate-based

### Protective Layer

Material: LDPE sheet
Thickness: 50 μm
Pencil hardness test (protective layer only): 4B
Moisture permeability: 10 g/m²·24 h

### Measurement Method

### (1) Measurement of Moisture Permeability of Protective Layer

A protective layer was set in a measurement instrument and placed in an atmosphere of 40 °C and 90% RH for 48 hours. After water vapor was supplied from one side, the amount of water that permeated the layer was measured to determine moisture permeability.

### (2) Measurement of Adhesion Strength

An adhesive layer and a protective layer were adhered to a 188 μm-thick PET film cut to a 25 mm square and pulled at 180 degrees to the PET film at a speed of 300 mm/min by using an autograph.

### (3) Evaluation of Radio Wave Reflectivity

The reception intensity of incident waves of 4.7 GHz and 28 GHz was measured while the incidence angle and reflection angle were changed. The results were compared with the reception intensity of an aluminum plate for evaluation. The reception intensity was evaluated and rated “A” if the reception intensity was equivalent to that of the aluminum plate, “B” if the difference in reception intensity compared to that of the aluminum plate was −10 dB or more and less than −20 dB, and “C” if the difference in reception intensity compared to that of the aluminum plate was −20 dB or more.

### (4) Measurement of Total Light Transmittance and Measurement of Haze

A test specimen was cut to a 5 cm square and measured for total light transmittance and haze with a HM-150 haze meter (manufactured by Murakami Color Research Laboratory Co., Ltd.) according to a measurement method conforming to JIS-K7136:2000.

### (5) Measurement of Surface Resistivity

Each test specimen was subjected to a heat and moisture resistance test described in section (7) below and then measured with an EC-80P manufactured by Napson Corporation.

### (6) Method for Pencil Hardness Test

In accordance with JIS K 5600-5-4, a load in the range of 500±10 g was applied. The level of hardness at a point at which the mesh pattern of an electric conductor deformed was confirmed, and a hardness one level lower than the confirmed hardness was recorded as the hardness.

### (7) Method for Heat and Moisture Resistance Test

A test specimen was placed and left in a chamber of constant temperature and constant humidity adjusted to a temperature of 60 °C and a humidity of 95% RH for 500 hours and then taken out. After the test specimen was left at room temperature for 4 hours, the test specimen was visually observed to confirm whether foaming and whitening occurred. Thereafter, the (2) measurement of adhesive strength, (3) evaluation of radio wave reflectivity, (4) measurement of transmittance, and measurement of haze described above were performed again, and a comparison was made between before (initial stage) and after the heat and moisture resistance test. For adhesive strength, the ratio (initial ratio) of the adhesive strength after the heat and moisture resistance test to the adhesive strength before the heat and moisture resistance test (initial stage) was calculated.

### (8) Lightfastness Test

A test specimen was placed in a Ci4000 xenon Sunshine Weather-Ometer manufactured by Atlas Material Testing Technology LLC, and the inside of the chamber was set to an irradiance of 60 W/m² (300 to 400 nm), a black standard temperature (BST) of 65±3 °C, a humidity of 50±5% RH, and a temperature inside the chamber of 38 °C. The yellowness Δb* was measured before and after irradiation for 1300 hours (equivalent to one year of direct sunlight). Thereafter, the (3) evaluation of radio wave reflectivity, (4) measurement of transmittance, and measurement of haze described above were performed again, and a comparison was made before (initial stage) and after the lightfastness test.

### Test Results

Tables 1-1 and 1-2 show the test results of the Examples, and Table 2 shows the test results of the Comparative Examples.

TABLE 1-1

| | | | Pencil | Moisture | | | Exam- | Exam- | Exam- | Exam- | Exam- | Exam- |
|---|---|---|---|---|---|---|---|---|---|---|---|---|
| | | | Hard- | Perme- | Acid | Hydroxyl | ple | ple | ple | ple | ple | ple |
| | | | ness | ability | Value | Value | 1 | 2 | 3 | 4 | 5 | 6 |
| Conductive | Grating Pitch | 30 μm | | | | | ● | ● | ● | ● | ● | ● |
| Layer | | 45 μm | | | | | | | | | | |
| | | 100 μm | | | | | | | | | | |
| | Line Width | 0.8 μm | | | | | ● | ● | ● | ● | ● | ● |
| | | 2.3 μm | | | | | | | | | | |
| | Line Thickness | 0.5 μm | | | | | ● | ● | ● | ● | ● | ● |
| | | 1.6 μm | | | | | | | | | | |
| | Metal Type | Ag | | | | | ● | ● | ● | ● | ● | ● |
| | | Cu | | | | | | | | | | |
| Protective | PET | Thickness: 125 μm | F | | | | ● | ● | ● | ● | | |
| Layer | | | 3H | 4.8 | | | | | | | | |
| | | 75 | F | 8.0 | | | | | | | ● | |
| | | 50 | F | 12 | | | | | | | | ● |
| | | | 3H | 4.8 | | | | | | | | |
| | | 38 | F | 16 | | | | | | | | |
| | | 25 | F | 24 | | | | | | | | |
| | PP | 50 | 8 | 4.5 | | | | | | | | |
| | LDPE | 50 | 48 | 10 | | | | | | | | |
| Adhesive | Adhesive | X313-295S-14 | | | 0.8 | 115 | ● | | | | | |
| Layer | | 2980 | | | 0.5 | 95 | | | | | ● | ● |
| | | 2006HE | | | 30 | 10 | | ● | | | | |
| | | 2137KH | | | 10 | 8.0 | | | ● | | | |
| | | 1604N | | | 45 | 6.6 | | | | ● | | |
| | | 1502C | | | 0.1 | 8.8 | | | | | | |
| | | 2147 | | | 4.0 | 32 | | | | | | |
| | Crosslinking | L-45K | | | | | ● | ● | ● | ● | ● | ● |
| | Agent | E-AX | | | | | | | | | | |
| Evaluation | Adhesive | Initial Stage | | | | | 12.8 | 10.4 | 15.3 | 6.1 | 10.4 | 10.4 |
| | Strength | After Heat and | | | | | 24.5 | 12.6 | 14.8 | 13.1 | 12.6 | 12.6 |
| | | Moisture | | | | | | | | | | |
| | | Resistance Test | | | | | | | | | | |
| | | Ratio to Value in | | | | | 1.9 | 1.2 | 1.0 | 2.1 | 1.2 | 1.2 |
| | | Initial Stage | | | | | | | | | | |
| | Radio Wave | Initial Stage | | | | | A | A | A | A | A | A |
| | Reflectivity | After Heat and | | | | | A | A | A | A | A | A |
| | | Moisture | | | | | | | | | | |
| | | Resistance Test | | | | | | | | | | |
| | | After Lightfastness | | | | | A | A | A | A | A | A |
| | | Test | | | | | | | | | | |
| | Transmittance | Initial Stage | | | | | 90 | 90 | 90 | 90 | 90 | 90 |
| | | After Heat and | | | | | 90 | 90 | 90 | 90 | 90 | 90 |
| | | Moisture | | | | | | | | | | |
| | | Resistance Test | | | | | | | | | | |
| | | After Lightfastness | | | | | 89 | 89 | 89 | 89 | 89 | 89 |
| | | Test | | | | | | | | | | |
| | Haze | Initial Stage | | | | | 1 | 1 | 1 | 1 | 1 | 1 |
| | | After Heat and | | | | | 1 | 1 | 1 | 1 | 1 | 1 |
| | | Moisture | | | | | | | | | | |
| | | Resistance Test | | | | | | | | | | |
| | | After Lightfastness | | | | | 2 | 1 | 1 | 1 | 1 | 1 |
| | | Test | | | | | | | | | | |
| | Surface | | | | | | 3.1 | 3.8 | 3.4 | 3.2 | 3.8 | 3.8 |
| | Resistivity | | | | | | | | | | | |
| | Pencil Hardness | | | | | | 4H | 4H | 4H | 4H | 4H | 4H |
| | Test | | | | | | | | | | | |
| | Heat and | Foaming | | | | | None | None | None | None | None | None |
| | Moisture | Whitening | | | | | None | None | None | None | None | None |
| | Resistance Test | | | | | | | | | | | |
| | Lightfastness | Yellowness Δb* | | | | | 4.1 | 4.8 | 5.1 | 5.3 | 4.8 | 4.8 |
| | Test | | | | | | | | | | | |

TABLE 1-2

| | | | Pencil | Moisture | | Hydrox- | Exam- | Exam- | Exam- | Exam- | Exam- | Exam- | Exam- |
|---|---|---|---|---|---|---|---|---|---|---|---|---|---|
| | | | Hard- | Perme- | Acid | yl | ple | ple | ple | ple | ple | ple | ple |
| | | | ness | ability | Value | Value | 7 | 8 | 9 | 10 | 11 | 12 | 13 |
| Conductive | Grating Pitch | 30 μm | | | | | | ● | ● | ● | ● | ● | |
| Layer | | 45 μm | | | | | ● | | | | | | |
| | | 100 μm | | | | | | | | | | | ● |
| | Line Width | 0.8 μm | | | | | ● | ● | ● | ● | ● | ● | |
| | | 2.3 μm | | | | | | | | | | | ● |
| | Line Thickness | 0.5 μm | | | | | ● | ● | ● | ● | ● | ● | |
| | | 1.6 μm | | | | | | | | | | | ● |
| | Metal Type | Ag | | | | | ● | ● | ● | ● | ● | ● | |
| | | Cu | | | | | | | | | | | ● |
| Protective | PET | Thickness: | F | 4.8 | | | ● | ● | ● | ● | | | |
| Layer | | 125 μm | 3H | | | | | | | | ● | | |
| | | 75 | F | 8.0 | | | | | | | | | |
| | | 50 | F | 12 | | | | | | | | | |
| | | | 3H | 4.8 | | | | | | | | | ● |
| | | 38 | F | 16 | | | | | | | | ● | |
| | | 25 | F | 24 | | | | | | | | | |
| | PP | 50 | 8 | 4.5 | | | | | | | | | |
| | LDPE | 50 | 48 | 10 | | | | | | | | | |
| Adhesive | Adhesive | X313-295S-14 | | | 0.8 | 115 | | | | | | | |
| Layer | | 2980 | | | 0.5 | 95 | ● | | | | ● | ● | ● |
| | | 2006HE | | | 30 | 10 | | | | | | | |
| | | 2137KH | | | 10 | 0.0 | | | | | | | |
| | | 1604N | | | 45 | 8.6 | | ● | | | | | |
| | | 1502C | | | 0.1 | 8.8 | | | ● | | | | |
| | | 2147 | | | 4.0 | 32 | | | | ● | | | |
| | Crosslinking | L-45K | | | | | ● | ● | | ● | ● | ● | ● |
| | Agent | E-AX | | | | | | | ● | | | | |
| Evaluation | Adhesive | Initial Stage | | | | | 10.4 | 19.3 | 11.1 | 7.6 | 10.4 | 10.4 | 10.4 |
| | Strength | After Heat and | | | | | 12.6 | 22.7 | 10.1 | 14.6 | 12.6 | 12.6 | 12.6 |
| | | Moisture | | | | | | | | | | | |
| | | Resistance Test | | | | | | | | | | | |
| | | Ratio to Value | | | | | 1.2 | 1.2 | 0.9 | 1.9 | 1.2 | 1.2 | 1.2 |
| | | in initial Stage | | | | | | | | | | | |
| | Radio Wave | Initial Stage | | | | | A | A | A | A | A | A | A |
| | Rellectivity | After Heat and | | | | | A | A | A | A | A | A | A |
| | | Moisture | | | | | | | | | | | |
| | | Resistance Test | | | | | | | | | | | |
| | | After | | | | | A | A | A | A | A | A | A |
| | | Lightfastness | | | | | | | | | | | |
| | | Test | | | | | | | | | | | |
| | Transmittance | Initial Stage | | | | | 90 | 90 | 88 | 90 | 90 | 90 | 78 |
| | | After Heat and | | | | | 90 | 90 | 88 | 89 | 90 | 00 | 78 |
| | | Moisture | | | | | | | | | | | |
| | | Resistance Test | | | | | | | | | | | |
| | | After | | | | | 89 | 87 | 85 | 86 | 89 | 89 | 78 |
| | | Lightfastness | | | | | | | | | | | |
| | | Test | | | | | | | | | | | |
| | Haze | Initial Stage | | | | | 1 | 1 | 8 | 1 | 1 | 1 | 5 |
| | | After Heat and | | | | | 1 | 1 | 8 | 8 | 1 | 1 | 5 |
| | | Moisture | | | | | | | | | | | |
| | | Resistance Test | | | | | | | | | | | |
| | | After | | | | | 1 | 4 | 24 | 3 | 1 | 1 | 5 |
| | | Lightfastness | | | | | | | | | | | |
| | | Test | | | | | | | | | | | |
| | Surface | | | | | | 3.8 | 3.5 | 3.6 | 3.7 | 3.8 | 3.8 | 0.7 |
| | Resistivity | | | | | | | | | | | | |
| | Pencil Hardness | | | | | | 4H | 4H | 4H | 4H | 4H | 4H | 4H |
| | Test | | | | | | | | | | | | |
| | Heat and | Foaming | | | | | None | None | None | None | None | None | None |
| | Moisture | Whitening | | | | | None | None | None | None | None | None | None |
| | Resistance Test | | | | | | | | | | | | |
| | Lightfastness | Yellowness | | | | | 4.8 | 5.7 | 10.4 | 5.3 | 4.8 | 4.8 | 2.3 |
| | Test | Δb* | | | | | | | | | | | |

TABLE 2

| | | | Pencil | Moisture | Acid | Hydroxyl | Comparative | Comparative | Comparative | Comparative | Comparative | Comparative | Comparative | Comparative |
|---|---|---|---|---|---|---|---|---|---|---|---|---|---|---|
| | | | Hardness | Permeability | Value | Value | Example 1 | Example 2 | Example 3 | Example 4 | Example 5 | Example 6 | Example 7 | Example 8 |
| Conductive | Grating Pitch | 30 μm | | | | | ● | | ● | ● | ● | ● | ● | ● |
| Layer | | 45 μm | | | | | | ● | | | | | | |
| | | 100 μm | | | | | | | | | | | | |
| | Line Width | 0.8 μm | | | | | ● | ● | ● | ● | ● | ● | ● | ● |
| | | 2.3 μm | | | | | | | | | | | | |
| | Line Thickness | 0.6 μm | | | | | ● | ● | ● | ● | ● | ● | ● | ● |
| | | 1.6 μm | | | | | | | | | | | | |
| | Metal Type | Ag | | | | | | | ● | ● | ● | ● | ● | ● |
| | | Cu | | | | | | | | | | | | |
| Protective | PET | Thickness: 125 μm | F | 4.8 | | | | | | | | | | |
| Layer | | | 3H | | | | | | | | | | | |
| | | 75 | F | 9.0 | | | | | | | | | | |
| | | 50 | F | 12 | | | | | | | | | | |
| | | | 3H | 4.8 | | | | | | | | | | |
| | | 38 | F | 16 | | | | | ● | ● | | | | |
| | | 25 | F | 24 | | | | | | | ● | ● | | |
| | PP | 50 | 8 | 4.5 | | | | | | | | | ● | |
| | LDPE | 50 | 48 | 10 | | | | | | | | | | ● |
| Adhesive | Adhesive | X313-295S-14 | | | 0.8 | 115 | | | | | | | | |
| Layer | | 2980 | | | 0.5 | 95 | | | ● | ● | ● | ● | ● | ● |
| | | 2006HE | | | 30 | 10 | | | | | | | | |
| | | 2137KH | | | 10 | 6.0 | | | | | | | | |
| | | 1604N | | | 45 | 6.6 | | | | | | | | |
| | | 1502C | | | 0.1 | 6.6 | | | | | | | | |
| | | 2147 | | | 4.0 | 32 | | | | | | | | |
| | Crosslinking | L-45K | | | | | | | ● | ● | ● | ● | ● | ● |
| | Agent | E-AX | | | | | | | | | | | | |
| Evaluation | Adhesive | Initial Stage | | | | | — | — | 10.4 | 10.4 | 10.4 | 10.4 | 10.4 | 10.4 |
| | Strength | After Heat and | | | | | — | — | 12.6 | 12.6 | 12.6 | 12.6 | 12.6 | 12.6 |
| | | Moisture | | | | | | | | | | | | |
| | | Resistance Test | | | | | | | | | | | | |
| | | Ratio to Value in | | | | | — | — | 1.2 | 1.2 | 1.2 | 1.2 | 1.2 | 1.2 |
| | | Initial Stage | | | | | | | | | | | | |
| | Radio Wave | Initial Stage | | | | | C | C | C | C | C | C | C | C |
| | Reflectivity | After Heat and | | | | | C | C | C | C | C | C | C | C |
| | | Moisture | | | | | | | | | | | | |
| | | Resistance Test | | | | | | | | | | | | |
| | | After Lightfastness | | | | | C | C | C | C | C | C | C | C |
| | | Test | | | | | | | | | | | | |
| | Transmittance | Initial Stage | | | | | 90 | 90 | 90 | 90 | 90 | 90 | 90 | 90 |
| | | After Heat and | | | | | — | — | — | — | — | — | — | — |
| | | Moisture | | | | | | | | | | | | |
| | | Resistance Test | | | | | | | | | | | | |
| | | After Lightfastness | | | | | — | — | — | — | — | — | — | — |
| | | Test | | | | | | | | | | | | |
| | Haze | Initial Stage | | | | | — | — | — | — | — | — | — | — |
| | | After Heat and | | | | | — | — | — | — | — | — | — | — |
| | | Moisture | | | | | | | | | | | | |
| | | Resistance Test | | | | | | | | | | | | |
| | | After Lightfastness | | | | | — | — | — | — | — | — | — | — |
| | | Test | | | | | | | | | | | | |
| | Surface | | | | | | 214 | 221 | — | — | — | — | — | — |
| | Resistivity | | | | | | | | | | | | | |
| | Pencil Hardness | | | | | | 6B | 6B | B | B | B | B | 2B | 5B |
| | Test | | | | | | | | | | | | | |
| | Heat and | Foaming | | | | | — | — | None | None | None | None | None | None |
| | Moisture | Whitening | | | | | — | — | None | None | None | None | None | None |
| | Resistance Test | | | | | | | | | | | | | |
| | Lightfastness | Yellowness Δb* | | | | | — | — | — | — | — | — | — | — |
| | Test | | | | | | | | | | | | | |

As can be seen from Tables 1-1, 1-2, and 2, Examples 1 to 13 resulted in “4H” in the pencil hardness test performed on test specimens, whereas Comparative Examples 1 to 8 resulted in “6B,” “B,” “2B,” and “5B,” At that time, Examples 1 to 13 were evaluated as “A” for radio wave reflectivity, whereas Comparative Examples 1 to 8 were evaluated as “C” for radio wave reflectivity.

These results indicate that the evaluation of radio wave reflectivity depends on the hardness of the protective layer, and therefore, it is necessary to select an appropriate level of hardness for the protective layer in order to maintain good radio wave reflectivity. Additionally, Comparative Examples 1 and 2 had a high value for surface resistivity and rated “C” for radio wave reflectivity. This indicates that when the value of surface resistivity was high, the protective layer was peeled off, deformed, or damaged, and the radio wave reflectivity was deteriorated in this case.

In short, the results indicate that because Examples 1 to 13 had “F” or higher in a pencil hardness test, the electric conductor can be protected while the radio wave reflectivity is not impaired, ensuring practical radio wave reflectivity.

Additionally, Examples 1 to 13 were rated “A” for radio wave reflectivity even after the heat and moisture resistance test and after the lightfastness test, indicating that radio wave reflectivity was not impaired. After these tests, Examples 1 to 13 were also confirmed to have a haze of less than 30% and a total light transmittance of 70% or more, indicating that transparency was maintained. Furthermore, Examples 1 to 13 had a yellowness of 15 or less after the lightfastness test, indicating that discoloration did not progress significantly, and deterioration was unlikely to occur.

### Evaluation Test B

In Examples 21 to 26 and Comparative Example 21, radio wave reflectors 11 were produced and subjected to evaluation tests. Then, the radio wave reflectors 11 of Examples 21 to 26 and Comparative Example 1 were subjected to evaluation tests for the difference in yellow index, the rate of change r in surface resistivity during a heat and moisture resistance test, and the difference in reflection intensity. However, the radio wave reflector 11 of the present invention is not limited to those of Examples 21 to 26.

### EXPLANATION OF EXAMPLES AND COMPARATIVE EXAMPLES

### Example 21

The radio wave reflector 11 produced in Example 21 had the same structure as that in the embodiment shown in FIGS. 2 to 4. The radio wave reflector 11 has a square planar shape, with a side length L10 of 20 cm and a thickness L1 of 250 μm.

The radio wave reflector 11 has a radio wave reflection intensity of −30 dB or more in the frequency band of 3 GHz or more and 300 GHz or less. Furthermore, when the radio wave reflector 11 reflects an incident wave with a frequency of 3 GHz or more and 300 GHz or less, the maximum value of reflection intensity of the radio wave is −20 dB (which is also referred to as “maximum radio wave reflection intensity”).

A synthetic resin material sheet made of PET (Lumirror 50T60, manufactured by Toray Industries, Inc.) was used as the substrate 13, and the thickness L2 of the substrate 13 was set to 50 μm.

The electric conductors 12 of the conductive layer 16 were a linear-shaped, thin metal film made of silver (Ag), with a thickness (film thickness) L3 of 500 nm, a line width L6 of 0.5 μm, and a length L7 between adjacent electric conductors 12 of 60 μm. The conductive layer 16 had a surface resistivity of 1.7Ω/□, and an electric conductor coverage of 3.3%. The distance L11 between the edge 13a of the substrate 13 of the laminate 18 (i.e., the edge of the protective layer 15) and the electric conductors 12 was set to 10 mm.

A rubber-based adhesive was used as the adhesive layer 14. Specifically, the adhesive layer 14 was created by adding 100 parts by weight of a rubber-based polymer (a mixture of 50% by mass of a styrene-(ethylene-propylene)-styrene block copolymer and 50% by mass of a styrene-(ethylene-propylene) block copolymer, styrene content: 15%, and weight average molecular weight: 130,000), 40 parts by weight of a synthetic resin (manufactured by Mitsui Chemicals, Inc., FMR-0150), 20 parts by weight of a softener (manufactured by JX Nippon Oil & Energy Corporation, LV-100), 0.5 parts by weight of an antioxidant (manufactured by ADEKA Corporation, ADK STAB AO-330), and 150 parts by weight of toluene to a reactor equipped with a condenser, a nitrogen-feeding tube, a thermometer, a dropping funnel, and a stirrer, and stirring the mixture at 40 °C for 5 hours. The thickness L4 of the adhesive layer 14 was set to 150 μm. The dielectric loss tangent of the adhesive layer 14 was 0.04.

A synthetic resin sheet made of PET (Lumirror 50T60, manufactured by Toray Industries, Inc.) was used as the protective layer 15. The thickness L5 of the protective layer 15 was set to 50 μm.

In Example 21, the sealant 17 was not provided. The thickness L1 of the radio wave reflector 11, the thickness L3 of the electric conductor 12, the thickness L2 of the substrate 13, the thickness L4 of the adhesive layer 14, and the thickness L5 of the protective layer 15 were determined by measuring them at multiple arbitrary positions and calculating the average of the obtained measurement values. The thickness L1 to thickness L5 were measured by using, for example, a reflectance spectroscopy film thickness meter (e.g., F3-CS-NIR, manufactured by Filmetrics, Inc.) as a measurement instrument.

The method for producing the radio wave reflector 11 of Example 21 is explained below. First, the electric conductor 12 is formed on the substrate 13. A core layer of 0.01 to 3 μm is formed on one surface of copper foil with a thickness of 5 to 200 μm that is sufficiently strong as a metal layer according to a method such as electrolytic or electroless plating. Then, the electric conductor 12 is formed in a predetermined arrangement pattern on the surface of the core layer according to a method such as electrolytic or electroless plating. Subsequently, the entire electric conductor 12 is covered by the substrate 13. The substrate 13 is coated with an adhesive beforehand. The copper foil and the core layer are then removed by etching, thereby forming the electric conductor 12 on the substrate 13.

Then, the protective layer 15 is adhered to the side opposite to the substrate 13 with the electric conductor 12 sandwiched therebetween by using the adhesive layer 14. The protective layer 15 is adhered to the electric conductor 12 on the substrate 13 by using the adhesive layer 14 in such a manner that no air bubbles are trapped, thereby producing the radio wave reflector 11.

### Example 22

The radio wave reflector 11 produced in Example 22 differed from the radio wave reflector 11 of Example 21 in terms of the distance L11 between the edge of the substrate 13 of the laminate 18 and the electric conductor 12. In the radio wave reflector 11 of Example 22, the distance L11 was 5 mm. The rest of the structure was the same as that in Example 21.

### Example 23

The radio wave reflector 11 produced in Example 23 differed from the radio wave reflector 11 in Example 21 and the radio wave reflector 11 in Example 22 in that the radio wave reflector 11 in Example 23 had the same structure as that in the embodiment shown in FIG. 7. The sealant 17 was provided around the laminate 18, and the length L12 by which the sealant 17 protrudes from the laminate 18 (the width of the sealant 17) was 5 mm. Sekisui Silicone Sealant Clear (model number: SSBCL-333, manufactured by Sekisui Fuller Co., Ltd., silicone resin) was used as the sealant 17. The distance L11 between the edge of the laminate 18 and the electric conductor 12 was zero, and the electric conductor 12 was located at the edge of the substrate 13 of the laminate 18. The radio wave reflector 11 had a side length L10 of 20.1 cm. The rest of the structure was the same as that in Example 21.

### Example 24

The radio wave reflector 11 produced in Example 24 had the same structure as in the embodiment shown in FIG. 7, as with Example 23. The difference from Example 23 is that the sealant 17 was made of an acrylic resin. The acrylic resin is polymethyl methacrylate (PMMA). The rest of the structure was the same as in Example 23.

### Example 25

The radio wave reflector 11 produced in Example 25 had the same structure as in the embodiment shown in FIG. 7, as with Example 23. The difference from Example 23 is that the sealant 17 was made of an epoxy resin. The epoxy resin contained jER828 (epoxy equivalent: 190, Mitsubishi Chemical Corporation) as an epoxy base agent, and jER Cure YN100 (amine value: 350 KOH mg/g, amine equivalent: 80.1, Mitsubishi Chemical Corporation) as a curing agent. The curing time was 3 days, and the curing temperature was 40 °C. The rest of the structure was the same as in Example 23.

### Example 26

The radio wave reflector 11 produced in Example 26 differed from that in Example 21 in terms of the distance L11 between the edge 13a of the substrate 13 of the laminate 18 and the electric conductor 12. The distance L11 was 1 mm. The rest of the structure was the same as in Example 21.

### Comparative Example 21

The radio wave reflector 11 produced in Comparative Example 21 differed from that in Example 21 in the following respects. The distance L11 between the edge of the substrate 13 of the laminate 18 and the electric conductor 12 was zero; i.e., the electric conductor 12 was located along the edge of the substrate 13 of the laminate 18. The rest of the structure was the same as in Example 21.

### Method of Measurement and Method of Calculation Measurement of Yellow Index and Calculation of Difference in Yellow Index

The difference in yellow index was calculated according to the following method. First, the yellow index (YI0) of the target objects, i.e., the radio wave reflectors 11 of Examples 21 to 26 and Comparative Example 1 (which are also referred to as “samples” below), was measured. Second, the samples were then subjected to a heat and moisture resistance test, and the yellow index (YI) of the samples after the heat and moisture resistance test was measured. Third, the yellow index (YI0) before the heat and moisture resistance test was subtracted from the yellow index (YI) after the heat and moisture resistance test to determine the difference in yellow index. Specifically, the difference in yellow index=YI−YI0. The yellow index was measured according to a method conforming to JIS K7373. In the heat and moisture resistance test, the radio wave reflectors 11 were left in a chamber of constant temperature and constant humidity adjusted to a temperature of 60 °C and a humidity of 95% RH (relative humidity of 95%) for 500 hours and removed from the chamber of constant temperature and constant humidity, followed by being left to stand at room temperature for 4 hours.

### Measurement of Surface Resistivity

Surface resistivity of each sample before the heat and moisture resistance test was measured by bringing measurement terminals into contact with the surface of the conductive layer 16, which was exposed as formed during the production of the sample, according to the four-terminal method conforming to JIS K6911. Because the conductive layer 16 was not exposed, the samples after the heat and moisture resistance test were measured according to the eddy-current method using a non-contact resistance meter (manufactured by Napson Corporation, product name: EC-80P, or an equivalent product).

### Calculation of Rate of Change in Surface Resistivity During Heat and Moisture Resistance Test

The rate of change r in surface resistivity during the heat and moisture resistance test was calculated according the following method. First, the surface resistivity of the samples was measured before the heat and moisture resistance test. Second, the samples were subjected to the heat and moisture resistance test, and the surface resistivity of the samples after the heat and moisture resistance test was measured. The rate of change in surface resistivity during the heat and moisture resistance test was calculated from the following formula:

Rate of change r in surface resistivity during heat and moisture resistance test=(surface resistivity r1 before heat and moisture resistance test−surface resistivity r2 after heat and moisture resistance test)/surface resistivity r1 before heat and moisture resistance test×100.

The surface resistivity of the electric conductor 12 of the conductive layer 16 was determined to be the surface resistivity of the radio wave reflector 11.

A rate of change in surface resistivity of less than 10% was evaluated as “A,” and a rate of change in surface resistivity of 10%, or more and less than 20% was evaluated as “B,” with a rate of change in surface resistivity of 20% or more being evaluated as “C”. When the rate of change in surface resistivity is rated “A” or “B,” it means that surface resistivity does not change significantly before and after a heat and moisture resistance test, and the radio wave reflector 11 is practical for use.

### Measurement of Reflection Intensity

The intensity of a wave reflected by a sample and the frequency band in which the reflection intensity is −30 dB or more were measured according to the method for measuring the amount of reflection described in JIS R1679:2007. The sample was placed flat on a sample table, and a transmitting antenna and a receiving antenna were arranged according to the incident angle 91 and the reflection angle 92 of the radio wave (01, 02=45 degrees). The distance between the sample and the receiving antenna and the distance between the sample and the transmitting antenna were set to 1 m. Radio waves with frequencies varying from 3 GHz to 300 GHz (a radio wave of 3 GHz, a radio wave of 5 GHz, and radio waves above 30 GHz in 30 GHz increments up to 300 GHz (i.e., 30, 60, 90, 120 . . . 300 GHz)) were output from the transmitting antenna, and the amount of reflection (reflection intensity) relative to the radio waves was measured. Additionally, the frequency band in which the amount of reflection was −30 dB or more was determined.

First, a reference metal plate (aluminum A1050 plate, thickness: 3 nm) was placed on a sample table, and the reception level was measured and recorded by using a scalar network analyzer. At this time, the coaxial cables of the receiving antenna and the transmitting antenna were directly connected in a scalar network analyzer, and the signal level at each frequency was calibrated to zero. Thereafter, the apparatus was reconfigured, and measurement was performed. The reference metal plate was removed from the sample table, and a sample was placed on the sample table, followed by measuring and recording the reception level. The amount of reflection in the direction of specular reflection of the radio wave reflector 11 (measurement target) was calculated by subtracting the reception level of the reference metal plate from the measured reception level. The same measurement was performed for each sample. When the frequency of the radio wave was 10 GHz or less, a millimeter wave lens was appropriately used to irradiate the sample with a plane wave, taking into consideration the first Fresnel radius of the rectangular horn antenna.

### Difference in Reflection Intensity

The reflection intensity of radio waves with frequencies varying from 3 GHz to 300 GHz (a radio wave of 3 GHz, a radio wave of 5 GHz, and radio waves above 30 GHz in 30 GHz increments up to 300 GHz (i.e., 30, 60, 90, 120 . . . 300 GHz)) by the radio wave reflector 11 before and after the heat and moisture resistance test was measured. Subsequently, the difference (absolute value) in radio wave reflection intensity before and after the heat and moisture resistance test was calculated for each frequency. Table 3 shows the maximum difference. A difference (absolute value) smaller than 2 indicates that the reflection intensity of the radio wave reflector 11 is not reduced, and thus, the radio wave reflector 11 is practical for use.

### Test Results

Table 3 shows the test results. In Examples 21 and 22, the respective electric conductors 12 are formed 10 mm and 5 mm medially from the edge 13a of the substrate 13 of the laminate 18, and the difference in yellow index before and after the heat and moisture resistance test in Examples 21 and 22 is small, at 0.4 and 0.6, respectively. The rate of change in surface resistivity was also rated as “A.” Additionally, the reflection intensity of the radio wave reflector 11 in Example 21 before and after the heat and moisture resistance test was −20 dB in the entire frequency range of 3 GHz or more to 300 GHz or less. The difference in reflection intensity was zero, and there was no reduction in reflection intensity at all. As described above, in Examples 21 and 22, no deterioration was observed before or after the heat and moisture resistance test.

In Example 26, the electric conductor 12 was formed 1 mm inward from the edge of the laminate 18, and the difference in yellow index was 3.2, which is greater than that of Example 21. However, the rate of change in surface resistivity was rated as “B.” At a frequency of 27.5 GHz within the frequency range of 3 GHz or more and 300 GHz or less, the radio wave reflector 11 had a reflection intensity of −20 dB before the heat and moisture resistance test, and a reflection intensity of −21 dB after the heat and moisture resistance test, with the difference in reflection intensity being 1. Although the reflection intensity was slightly decreased, the radio wave reflector 11 was practical for use.

In Examples 23 to 25, the electric conductor 12 was formed on the edge 13a of the substrate 13 of the laminate 18, but the electric conductor 12 was covered by the sealant 17. In Examples 23 to 25, a silicone resin, an acrylic resin, and an epoxy resin were respectively used as the sealant 17. In all of Examples 23 to 25, the difference in the yellow index was small, 0.1, and the rate of change in surface resistivity was rated as “A.” Additionally, the radio wave reflector 11 of Example 21 had a reflection intensity of −20 dB before and after the heat and moisture resistance test in the entire frequency range of 3 GHz or more to 300 GHz or less. The difference in reflection intensity was zero, and there was no reduction in reflection intensity at all.

In contrast, in Comparative Example 1, the electric conductor 12 was formed on the edge 13a of the substrate 13 of the laminate 18 with the sealant 17 not provided, and the electric conductor 12 was thus exposed to the outside. The difference in yellow index was large, 4.0, and the rate of change in surface resistivity was rated as “C.” At a frequency of 27.5 GHz within the frequency range of 3 GHz or more to 300 GHz or less, the radio wave reflector 11 had a reflection intensity of −20 dB before the heat and moisture resistance test, and a reflection intensity of −25 dB after the heat and moisture resistance test reflection, with the difference in reflection intensity being 5, indicating significantly reduced reflection intensity.

TABLE 3

| | | Example | Example | Example | Example | Example | Example | Comparative |
|---|---|---|---|---|---|---|---|---|
| | | 21 | 22 | 23 | 24 | 25 | 26 | Example 21 |
| Distance between Edge of Laminate | | 10 | 5 | 0 | 0 | 0 | 1 | 0 |
| and Electric Conductor (mm) | | | | | | | | |
| Presence or Absence of Sealant | | Absent | Absent | Present | Present | Present | Absent | Absent |
| Type of Sealnt | | — | — | Silicone | Acrylic | Epoxy | — | — |
| Evaluation | Difference in Yellow Index | 0.4 | 0.6 | 0.1 | 0.1 | 0.1 | 3.2 | 4.0 |
| | Rate of Change in Surface | A | A | A | A | A | B | C |
| | Resistivity during Heat and | | | | | | | |
| | Moisture Resistance Test | | | | | | | |
| | Difference in Reflection | 0 | 0 | 0 | 0 | 0 | 1 | 5 |
| | Intensity | | | | | | | |

### VARIATION EXAMPLES

The embodiment above is only one of many possible embodiments of the present invention. The embodiment can be modified in various ways according to the design etc. as long as the object of the present invention can be achieved. The following is a list of variation examples of the embodiment. The variation examples described below can be combined as appropriate for application.

### (1) Variation Example 1

The conductive layer 16 may have, for example, a metamaterial structure. The metamaterial structure is the following: electric conductors 12 (dielectric materials) in a sheet form are arranged in an equal periodic pattern. This periodic arrangement structure imparts a negative permittivity to the conductive layer 16 and allows it to reflect radio waves in a specific frequency band determined based on the periodic interval. The shape of the electric conductor 12 is not particularly limited, and the electric conductor 12 may be of any shape described above. For example, as shown in FIG. 9, each electric conductor 12 may be square. The length L20 of one side of each electric conductor 12 and the distance L21 between adjacent electric conductors 12 may be set so that the electric conductors 12 reflect radio waves with a frequency of 3 GHz or more and 300 GHz or less. In this case, the length L20 of one side of each electric conductor 12 may be 0.7 mm or more and 800 mm or less, and the distance L21 may be 1 μm or more and 1000 μm or less. The thickness L3 of the electric conductors 12 is preferably 350 nm (0.35 μm) or less, more preferably 100 nm or less, and even more preferably 50 nm or less. The number of electric conductors 12 is appropriately set according to the size (area) of the substrate 13. For example, the electric conductors 12 may be formed in a total of four, two vertically and two horizontally on the substrate 13, in accordance with the size of the substrate 13. In this case, the length L20 of one side of each electric conductor 12 is set to 77.460 mm, and the distance L21 between the adjacent electric conductors 12 is set to 100 μm, with the thickness L3 being set to 350 nm (0.35 μm) or less. The conductive layer 16 is not limited to a metamaterial structure, and may also have any structure of the following: a metal-nanowire-laminated film, multi-layer graphene, and partially exfoliated graphite.

### (2) Variation Example 2

As shown in FIG. 10, the radio wave reflector 11 may have a plurality of layers stacked in the up-down direction. For example, an conductive layer 16B is adhered onto a conductive layer 16A via an adhesive layer 14A, and a protective layer 15 is adhered onto the conductive layer 16B via an adhesive layer 14B. In the same manner as in the embodiment described above, the conductive layer 16A includes the substrate 13 and the electric conductor 12. The conductive layer 16B also includes the substrate 13 and the electric conductor 12.

The electric conductor 12 formed in the conductive layer 16 may be a laminate of three or more layers. Increasing the number of layers of the electric conductor 12 increases reflection intensity, but also increases the overall thickness of the radio wave reflector 11, thus decreasing flexibility as well as visible light transmittance. Thus, the number of layers is appropriately set according to, for example, the intended use, such as increasing the number of layers when providing the radio wave reflector 11 in a place where flexibility and transparency are not particularly required.

### (3) Variation Example 3

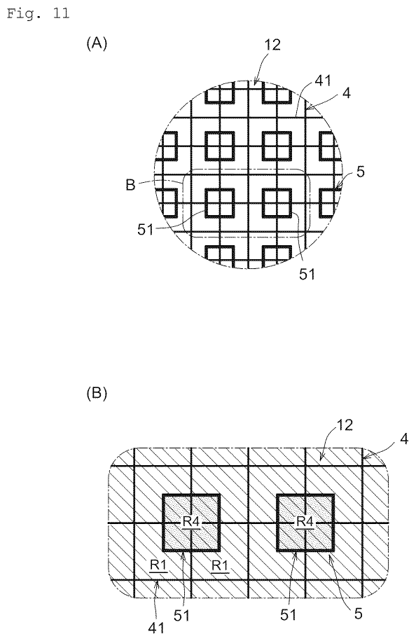

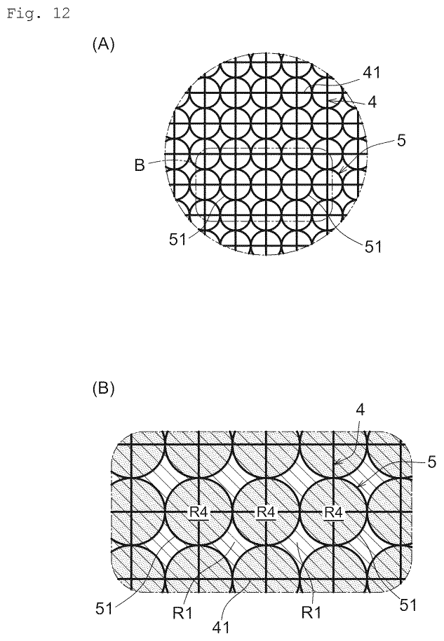

The electric conductor 12 may be of, for example, an embodiment as shown in FIG. 11. The electric conductor 12 is formed in a pattern in which a first conductive section 4 including a plurality of first enclosed sections 41 and a second conductive section 5 including a plurality of second enclosed sections 51 overlap each other. The first enclosed section 41 and the second enclosed section 51 have no shared portion when projected onto a plane parallel to the conductive layer.

In the first conductive section 4, the first enclosed sections 41 each surrounding a first region R1, in which the electric conductor 12 is not formed, are repeatedly formed at a constant pitch. Although the first conductive section 4 is formed in a grid pattern in this example, the first conductive section 4 may be formed in a pentagonal, hexagonal, circular, or other shape.

In the second conductive section 5, the second enclosed sections 51 each surrounding a fourth region R4, in which the electric conductor 12 is not formed, are repeatedly formed at a constant pitch. Each fourth region R4 is formed so as to span a plurality of adjacent first regions R1. The second conductive section 5 may be located on the same plane as the first conductive section 4, or may be located on a different plane. In other words, the second conductive section 5 may or may not be electrically connected to the first conductive section 4. Adjacent second conductive sections 5 are separated from each other, but may be in contact with each other. Although the second conductive section 5 is formed in a quadrangular shape, the second conductive section may be formed in a pentagonal, hexagonal, or other shape. FIG. 11, and FIG. 12, described later, show the arrangement of the electric conductor 12 in a plan view, and do not show the protective layer 15 or the adhesive layer 14.

The electric conductor 12 in the embodiment of variation example 3 can improve the diffuseness of radio waves. The “diffuseness of radio waves” as used herein means that the difference between the specular reflection intensity and the radio wave intensity around the specular reflection falls within a predetermined range.

### (4) Variation Example 4

The electric conductor 12 may be, for example, of the embodiment as shown in FIG. 12. The embodiment in FIG. 12 differs from the embodiment in FIG. 11 in terms of the shape of the second conductive section 5 (second enclosed sections 51); the second enclosed sections 51 are circular. The second enclosed sections 51 are arranged such that the center point of each second enclosed section 51 overlaps with an intersection of the first conductive section 4 formed in a grid pattern. The diameter of each second enclosed section 51 is equal to the grating pitch of the first conductive section 4. Specifically, adjacent second enclosed sections 51 are in contact with each other. Adjacent second enclosed sections 51 may be separated from each other. Since the rest of the structure is the same as that of variation example 3, the same reference numerals are used for the corresponding elements, and their descriptions are omitted.

Forming the second enclosed sections 51 in a circular shape as described above can reduce the effect of the incident direction with respect to the radio wave reflector 11 on the reflection intensity in a plan view. In other words, in this case, the variation in diffuseness according to the incident direction can be made small regardless of the direction from which a radio wave is incident on the radio wave reflector 11 in a plan view.

### (5) Variation Example 5

The conductive layer 16 of the radio wave reflector 11 does not necessarily have to include the substrate 13. In this case, all of the electric conductors 12 in the conductive layer 16 are supported by the adhesive layer 14 and the protective layer 15; in a plan view, all of the electric conductors 12 in the conductive layer 16 are covered by the adhesive layer 14 and the protective layer 15. When the protective layer 15 has adhesive properties, only the protective layer 15 may be provided. In other words, the protective layer 15 may support the electric conductors 12 as the substrate 13.

The radio wave reflector 11 as described above is installed so that the electric conductors 12 face the surface of the installation site with the electric conductors 12 being in direct contact with the surface of the installation site or via an adhesive layer or the like. In a plan view, the electric conductors 12 are covered by the adhesive layer 14, the protective layer 15, and the surface of the installation site so that the electric conductors 12 are not exposed to the outside to prevent deterioration.

### (6) Others

In the embodiment above, the radio wave reflector 11 is formed in a sheet shape. However, the present invention is not limited to this shape, and the radio wave reflector 11 may be in a shape of, for example, a plate, a block, a sphere, or a box. The object to which the radio wave reflector 11 is attached is not limited to building materials, and may be electrical appliances, architectural structures, automobiles, trains, aircraft, etc.

In the embodiment above, the radio wave reflector 11 includes the adhesive layer 14 between the conductive layer 16 and the protective layer 15. However, the radio wave reflector 11 does not necessarily have to include the adhesive layer 14 as long as the protective layer 15 has self-adhesion properties. The protective layer 15 may also be fixed to the conductive layer 16 by sealing the outer edge portion with a sealant, without using the adhesive layer 14. The protective layer 15 also does not necessarily have to be fixed to the conductive layer 16.

Although an embodiment of the present invention has been described above, the present invention is not limited to the embodiment above, and various modifications are possible without departing from the spirit of the present invention. The dimensions, materials, shapes, and relative positions of the elements described as an embodiment or shown in the drawings are merely illustrative examples and are not intended to limit the scope of the invention. For example, expressions indicating a relative or absolute position, such as “in a predetermined direction,” “along a predetermined direction,” “parallel,” “perpendicular,” “center”, ““concentric,” or “coaxial,” not only describe such a position strictly, but also describe a state in which the position is relatively displaced with a tolerance or with an angle or distance to the extent that the same functions can be achieved. For example, expressions indicating things being in an equivalent state, such as “same,” “equal,” and “homogeneous,” not only indicate a state of strict equality, but also indicate a state with a tolerance or a difference to the extent that the same functions can be achieved. For example, expressions describing shapes such as rectangular, cylindrical, or other shapes describe not only a square, a cylinder, or other shapes in the strict geometric sense, but also refer to shapes that include uneven portions, chamfers, etc. to the extent that the same effect can be achieved. Expressions such as “having,” “consisting of,” “comprising,” “including,” or “containing” one element are not exclusive expressions, and do not exclude the presence of other elements.

In the present specification, expressions with “substantially” such as “substantially parallel” or “substantially perpendicular” may be used. For example, “substantially parallel” means being practically parallel and includes not only a strictly parallel state but also a state with error of a few degrees. The same applies to other expressions with “substantially.”

In the present specification, expressions such as “edge portion” and “edge” are used, and these terms are distinguished from each other based on the presence or absence of “portion” at the end of the term. For example, the term “edge” means the end of an object, while the term “edge portion” means an area with a specific range that includes the “edge.” Any point that is within a specific range including the edge is defined as “edge portion.” The same applies to other expressions with “portion” at the end of the term.

### DESCRIPTION OF THE REFERENCE NUMERALS

11: radio wave reflector
12: electric conductor
12a: first region (region with no electric conductor)
12b: second region (region with no electric conductor)
12c: third region (region with no electric conductor
13: substrate
14: adhesive layer
15: protective layer
16: conductive layer
17: sealant
18: laminate

1. A radio wave reflector, comprising
a conductive layer containing an electric conductor to reflect a radio wave, and
a protective layer to protect the conductive layer,
the protective layer having a pencil hardness of F or higher under a surface load of 500 g in a pencil hardness test performed on the radio wave reflector.

2. The radio wave reflector according to claim 1, wherein the protective layer has a thickness of 38 μm or more.

3. The radio wave reflector according to claim 1, wherein the protective layer has a pencil hardness of F or higher under a surface load of 500 g in a pencil hardness test performed on the protective layer.

4. The radio wave reflector according to claim 1, further comprising an adhesive layer between the conductive layer and the protective layer, the adhesive layer bonding the conductive layer and the protective layer,
wherein the adhesive layer has a hydroxyl value of 5 mg KOH/g or more.

5. The radio wave reflector according to claim 1, further comprising an adhesive layer between the conductive layer and the protective layer, the adhesive layer bonding the conductive layer and the protective layer,
wherein the adhesive layer has an acid value of 50 mg KOH/g or less.

6. The radio wave reflector according to claim 1, wherein the protective layer has a moisture permeability of 20 g/m²·24 h or less at 40 °C and 90% RH.

7. The radio wave reflector according to claim 1, wherein a rate of decrease in adhesive strength of the protective layer to an adherend layer after a heat and moisture resistance test is 50% or less.

8. The radio wave reflector according to claim 1, wherein the radio wave reflector has a total light transmittance of 70% or more.

9. The radio wave reflector according to claim 1, further comprising an adhesive layer between the conductive layer and the protective layer, the adhesive layer bonding the conductive layer and the protective layer,
wherein the adhesive layer does not contain a UV inhibitor.

10. The radio wave reflector according to claim 1,
wherein
the conductive layer has a region in which the electric conductor is not present and has the electric conductor formed so as to surround the region,
the region includes a plurality of regions of the same shape, and
the plurality of regions of the same shape are arranged at a regular interval.

11. The radio wave reflector according to claim 1, wherein the radio wave reflector has a surface resistivity of 100Ω/□ or less after a heat and moisture resistance test.

12. The radio wave reflector according to claim 1, wherein the protective layer either contains a UV inhibitor or has a surface treated to block U, or both.

13. The radio wave reflector according to claim 1, wherein the radio wave reflector has a haze of 30% or less.

14. The radio wave reflector according to claim 1, wherein the radio wave reflector has a total light transmittance of 70% or more after a lightfastness test.

15. The radio wave reflector according to claim 1, wherein the radio wave reflector has an yellowness Δb* of 15 or less before and after a lightfastness test.

16. The radio wave reflector according to claim 1, comprising a laminate of the protective layer and the conductive layer, wherein the entire electric conductor is covered by the protective layer in a plan view.

17. The radio wave reflector according to claim 16,
wherein
the laminate further contains an adhesive layer that bonds the protective layer and the conductive layer,
the electric conductor is disposed medially from an edge of the protective layer in a plan view, and
the electric conductor is covered by the adhesive layer in a lateral view.

18. The radio wave reflector according to claim 17,
wherein
the conductive layer further contains a substrate supporting the electric conductor,
the electric conductor is located between the substrate and the protective layer, and
the electric conductor is disposed medially from an edge of the substrate in a plan view.

19. The radio wave reflector according to claim 16, wherein the electric conductor is disposed at least 5 mm medially from an edge of the protective layer in a plan view.

20. The radio wave reflector according to claim 16, wherein a sealant is present around the laminate, at least in a position corresponding to the conductive layer so as not to expose the electric conductor.

21. The radio wave reflector according to claim 16,
wherein
a difference in yellow index between after a heat and moisture resistance test and before the heat and moisture resistance test is 3 or less, wherein the heat and moisture resistance test includes leaving the radio wave reflector in a chamber of constant temperature and constant humidity adjusted to a temperature of 60 °C and a humidity of 95% RH for 500 hours, then removing the radio wave reflector from the chamber, and allowing the radio wave reflector to stand at room temperature for 4 hours.

22. The radio wave reflector according to claim 1,
wherein
when the radio wave reflector after a heat and moisture resistance test and the radio wave reflector before the heat and moisture resistance test specularly reflect incident waves with a frequency of 3 GHz or more and 300 GHz or less, there is at least one frequency of an incident wave at which a difference in intensity between a wave reflected by the radio wave reflector after the heat and moisture resistance test and a wave reflected by the radio wave reflector before the heat and moisture resistance test is within 3 dB, and
the heat and moisture resistance test includes leaving the radio wave reflector in a chamber of constant temperature and constant humidity adjusted to a temperature of 60 °C and a humidity of 95% RH for 500 hours, then removing the radio wave reflector from the chamber, and allowing the radio wave reflector to stand at room temperature for 4 hours.

23. A method for producing the radio wave reflector of claim 20, comprising the steps of
forming the laminate, and
providing the sealant to not expose the electric conductor,
the sealant being present around the laminate, at least in a position corresponding to the conductive layer in the radio wave reflector.

24. A method for installing the radio wave reflector of claim 20, comprising the steps of
attaching the laminate to an installation site, and
providing the sealant to not expose the electric conductor,
the sealant being present around the laminate, at least in a position corresponding to the conductive layer in the radio wave reflector.

25. The method according to claim 24,
wherein
the laminate comprises a plurality of the laminates,
in the attaching step, the laminates are attached to an installation site with an interval therebetween, and
in the sealant providing step, the sealant is provided in space between adjacent laminates of the laminates attached to the installation site with an interval therebetween.
